(19) United States
(12) Patent Application Publication
(10) Pub. No.: US 2026/0319457 A1
(43) Pub. Date: Oct. 15, 2026

(54) COMPUTER-IMPLEMENTED METHOD FOR USE IN A COMPUTER-AIDED PRODUCTION SYSTEM, AND PRODUCTION SYSTEM

(71) Applicant: TECHNISCHE UNIVERSITAT WIEN, Wien (AT)

(72) Inventors: Amir AGOVIC, Wien (AT); Christoph GABRIEL, Wien (AT); Thomas Fabian TRAUTNER, Wien (AT); Friedrich BLEICHER, Wien (AT)

(21) Appl. No.: 19/122,439

(22) PCT Filed: Oct. 20, 2023
(86) PCT No.: PCT/EP2023/079309

§ 371 Date: Apr. 18, 2025

(30) Foreign Application Priority Data
Oct. 20, 2022 (DE) 10 2022 127 792.5

(51) Int. Cl. G05B 19/4093

(52) U.S. Cl. CPC G05B 19/40937; G05B 19/40931

(57) ABSTRACT

The present invention relates to a computer-implemented method for use in a computer-aided production system (100), in particular for controlling an operation of a computer-aided production system (100), and to a production system (100), wherein the method comprises at least the following steps:
a1) providing component data assigned to one or more components (101),
   wherein the component data contain information on two or more feature groups (106) which are assigned to one or more components, wherein at least one feature group (106) is assigned to each component for which data are provided,
   wherein a feature group (106) in each case comprises a group of features which at least partially define the component (101) to which the feature group (106) is assigned, and
   wherein feature group data are assigned to each feature group (106),
a2) detecting operating data of the production system (100) and assigning the detected operating data of the production system (100) to at least one feature group (106),
b) selecting (S2) at least one feature group (106),
c) providing (S3) at least a portion of the feature group data assigned to the at least one selected feature group (106),
d) analysing (S4) the feature group data provided and determining a value of at least one variable characteristic of the selected feature group (106), and
e) storing, outputting and/or further processing the at least one value determined in step d).

### TECHNICAL FIELD

The present invention relates to a computer-implemented method for use in a computer-aided production system, in particular for controlling an operation of a computer-aided production system, wherein the production system is set up in particular for component processing. The invention also relates to a production system, a computer program, a computer-readable storage medium and a data processing device.

### BACKGROUND OF THE INVENTION

Computer-aided or computer-assisted production systems, in particular for component processing and/or manufacture, are generally known from the state of the art. In particular, CAx-supported systems are known (computer-aided x-systems), wherein the “X” stands for different workstations or process sections within production. In particular, for example, computer-aided or computer-aided systems are known which comprise at least one CAD station (Computer-Aided Design), i.e. a computer-aided construction area, a CAM station (Computer-Aided Manufacturing), i.e. a computer-aided manufacturing, and/or a CAQ station (Computer-Aided Quality), i.e. a computer-aided quality assurance/testing. In addition, CAE (Computer-Aided Engineering), i.e. computer-aided development, CAP (Computer-Aided Planning), i.e. computer-aided work planning, CNC (Computerized Numerical Control), i.e. computer-controlled manufacturing, computer-aided production planning and control (PPC) and computer-aided production data detection (PDD) are also known. Computer-aided or computer-supported production systems that have one or more of the aforementioned computer-aided stations are generally referred to as CIM production systems, i.e. computer-integrated manufacturing production systems.

According to https://de.wikipedia.org/wiki/Computer-integrated_manufacturing, last accessed on 3 Oct. 2022, “CIM” as defined by the AWF (Committee for Economic Manufacturing, 1985) describes the integrated use of IT in all areas of production and comprises the information technology interaction between CAD, CAP, CAM, CAQ and PPC. The aim is to integrate the technical and organisational functions for product creation.

Computer-aided or computer-supported production systems, in particular so-called CIM production systems and corresponding methods for use in these, in particular for the operation and control of such production systems, are generally known from the prior art.

An overview of this is provided, for example, by A. Agovic, T. Trautner, F. Bleicher, Digital Transformation—Implementation of Drawingless Manufacturing: A Case Study, Procedia CIRP, Volume 107, 2022, Pages 1479-1484, ISSN 2212-8271, https://doi.org/10.1016/j.procir.2022.05.178.

Furthermore, for example, WO 2020/204915 A1 discloses a construction and manufacturing system comprising a multi-axis machine tool having a cutting head capable of supporting a plurality of available tools and a part holder, wherein the cutting head and/or the part holder is fully controllable in at least two axes, a construction system operable using a computer to generate a 3D model of a part to be manufactured, and a machine learning model operable using the computer to analyse the part to be manufactured to identify features and generate a manufacturing plan based at least in part on the multi-axis machine tool and the plurality of tools and the part holder, and a machine learning model operable using the computer to analyse the part to be manufactured to identify features and develop a manufacturing plan based at least in part on the multi-axis machine tool and the plurality of tools available, wherein the manufacturing plan includes a tool type used for each feature, a feed rate for each tool type for each feature and a tool speed for each tool type for each feature.

WO 2019/226167 A1 further discloses a method for CAD operations and corresponding systems and computer-readable media. A method comprises receiving 3D solid model data of a part to be manufactured, receiving at least one rule from a rule database, applying the rule to the 3D solid model data using a rule engine, and generating an output according to the rule applied to the 3D solid model data. The rule may include an extraction section that identifies elements or features of the 3D solid model data, a logic section that applies a condition to the identified elements or features, and an action section that defines an action to be performed on identified elements or features that fulfil the condition. The output may include an annotation of product manufacturing information on elements or features of the 3D solid model data that match the rule.

WO 2018/083512 A1 discloses systems and a process for providing a machining method for manufacturing a feature of a part by receiving data of a set of features, wherein all feature data describe a feature to be manufactured and comprise a type of the feature and a set of attributes of the feature. Each processing method is assigned a set of ranking values to rank processing methods that are applicable in the same range of feature attributes. Data of an additional feature to be produced are received, wherein the type of the additional feature is the specified type and the set of attributes of the additional feature is a specific set of attributes. At least one machining process of the selected processes is provided based on its assigned ranking value in order to be able to be assigned to the additional feature as a machining process for producing the additional feature.

WO 2016/178107 A1 describes a method for identifying geometric clones in a modelling system or for simulating construction changes of a multi-part product and corresponding data processing systems and computer-readable media. The method described comprises selecting a template of a geometric shape and generating and storing an image of the template, identifying a candidate geometric shape in the system, and exploring the identified candidate geometric shape from a starting point until returning to the starting point or reaching a junction. The method comprises generating a map of the candidate geometric shape under investigation, comparing the map of the candidate geometric shape under investigation with the map of the template, and labelling the candidate geometric shape as a clone if it matches a predefined section of the template.

The use of features in production systems is also generally described in the VDI guideline VDI 2218, “Information processing in product development-feature technology”, March 2003.

The objectives to be achieved with such processes and production systems are usually to achieve a higher degree of automation, reduce the error rate, avoid method, media and/or system breaks, improve process reliability, reduce data redundancy, improve data consistency, up-to-dateness and quality, increase the standardisation rate, increase revision security or improve data version control, reduce costs, increase transparency regarding costs and required capacities, and/or generally optimise the production system and its operation.

### SUMMARY OF THE INVENTION

Against this background, it is a task of the present invention to provide an alternative method for use in a production system, i.e. for a production system, wherein it is in particular a task of the present invention to provide an improved method which in particular enables an improved operation of a production system, preferably an optimised operation of a production system, in particular an improved control of a production system.

Furthermore, it is a task of the present invention to provide an alternative production system, in particular an improved production system, which in particular enables improved operation, preferably optimised operation, in particular improved control.

Furthermore, it is a task of the present invention to provide an alternative, in particular improved computer program, an alternative, in particular improved computer-readable storage medium and an alternative, in particular improved data processing device, each of which in particular enables the provision of an alternative, in particular improved production system.

According to the invention, this task is solved by a method according to the invention, by a production system according to the invention, by a computer program according to the invention, by a storage medium according to the invention and by a data processing device according to the invention with the features according to the respective independent patent claims. Advantageous embodiments may be found in the dependent claims, the description and the figures. The wording of the claims is made the content of the description by express reference.

A computer-implemented method according to the present invention may in particular be configured for use in a computer-aided production system, that is to say for a computer-aided production system, in particular for use in a production system. In particular, the production system is set up for component processing, i.e. for manufacturing and/or processing components. In particular, the method may comprise one or more of the following steps:
a1) providing data, in particular component data, which may be assigned to one or more components which may preferably be manufactured and/or processed by the computer-aided production system, wherein the data may contain information on two or more feature groups which may be assigned to one or more components, wherein at least one feature group may be assigned to each component for which data are provided, wherein a feature group may in each case comprise a group of features which may at least partially define the component to which the feature group may be assigned, and wherein feature group data may be assigned to each feature group,
a2) detecting operating data of the production system and assigning the detected operating data of the production system to at least one feature group, whereby the detected operating data of the production system may become feature group data,
b) selecting at least one feature group,
c) providing at least some of the feature group data, which may be assigned to the at least one selected feature group, the provided feature group data preferably containing at least some of the operating data of the production system detected in step a2) and assigned to the feature group,
d) analysing feature group data, in particular the feature group data provided, and determining a value of at least one characteristic variable, in particular at least one variable characteristic of the feature group, and
e) storing, outputting and/or further processing a determined value, in particular the at least one value determined in step d).

A “production system” within the meaning of the present invention is in particular a system which is configured for processing and/or manufacturing at least one component, i.e. for component processing, wherein the production system need not be configured for complete manufacture or for complete processing of the component, but merely for carrying out at least one processing and/or manufacturing step within the process chain for processing and/or manufacturing the component.

A “computer-aided or computer-assisted or computer-aided production system” is in particular a production system which comprises at least one workstation which has a computer or a comparable device and/or is connected or may be connected to such a device for data exchange, wherein the computer or the comparable device is set up in particular for at least partial execution of a required task in the process chain of processing and/or manufacturing the component.

A production system within the meaning of the present invention has, in particular, at least one workstation, wherein a workstation within the meaning of the present invention is, in particular, a station which is set up to process at least some of the data assigned to a component.

A “workstation” within the meaning of the present invention may in particular be a manufacturing station, i.e. in particular a station with at least one machine tool. In particular, a workstation may be or comprise, for example, a cutting device, such as a milling machine, in particular a CNC milling machine, a lathe, in particular a CNC lathe, a forming machine, such as a press, or any other type of machine tool for manufacturing. In particular, a workstation may be a boring machine, a machining centre or a turning and milling machining centre.

The term “production” may be understood in particular in the sense of DIN 8580. Accordingly, a manufacturing station may be a station at which at least one processing step of a manufacturing process according to DIN 8580 may be carried out. In other words, a manufacturing station is set up in particular for carrying out at least one machining step of a manufacturing process, in particular a manufacturing process according to DIN 8580.

In addition to a manufacturing station, a workstation within the meaning of the present invention, in particular as part of a production system according to the invention, may also be a PPC station, i.e. a Production Planning and Control station. In particular, a workstation may also be a work preparation station, a production program planning station, a quantity planning station, a scheduling and/or capacity planning station, an order monitoring station, an order initiation station, a construction station and/or a testing and/or measuring station.

In other words, a workstation within the meaning of the present invention may be any station at which data assigned to the component are at least partially processed as part of a manufacturing and/or machining process of a component.

A workstation does not have to be configured to be able to process all data assigned to a component, but in the sense of the present invention it is sufficient if a workstation is set up to process only a subset of data assigned to a component.

In particular, a workstation may comprise or be a CAx station. Preferably, at least one workstation is a CAD station, a CAM station or a CAQ station or a combination thereof or comprises one of these.

A production system according to the present invention may in particular be a CIM production system.

A “component” within the meaning of the present invention is any workpiece, in particular any embodied workpiece, the manufacture and/or processing of which comprises at least one physical step, in particular a physical manufacturing step.

For the purposes of the invention, the “processing” of data assigned to a component, i.e. in particular of component data, means in particular at least one of generating, processing, storing, reading out, detecting, reading in, outputting, displaying, converting, buffering, changing, matching, checking, sorting, converting and any other data processing option, in particular any data processing option possible with the aid of a computer, in particular any electronic data processing option, and/or combinations thereof.

Data assigned to a component, i.e. component data, may in particular be data that define a geometry of the component (geometry data), such as dimensions, tolerances, in particular dimensional, shape and positional tolerances, and/or data that define one or more properties of the component (property data), such as material data, surface properties (roughness or similar). Component data may also be production data such as manufacturing parameters and/or specifications, such as the specification of which manufacturing process is to be used for at least one processing step of the component. Component data may also include associated machine tool data or control parameters or process parameters such as cutting speeds, feed rates, cutting depths, production aids, cutting heads, etc. and/or test and/or measurement data, which may include test and/or measurement program information in particular.

Data assigned to a component may in particular also be associated construction data (e.g. FEM data such as grid properties, number of nodes, etc.), manufacturing data (manufacturing process to be used, operating equipment to be used, NC program to be used), required process parameters such as, for example, process temperatures, rest times and/or temperature curves, and/or manufacturing sequence data, for example after which step which quality checks are to be carried out, order data, and/or component identification data, such as batch numbers, manufacturing time and location, etc.

Component data may also include work plan data, maturity level information, revision and/or change data, assembly information, associated equipment data, for example from suitable clamping devices or similar, as well as information on hazardous material classes, shelf life or recycling (e.g. on recycled volume/total volume) or on the CO2 balance.

Test program data may, for example, include information for a test or measurement to be applied. In particular, whether a component is to be measured optically or tactilely, for example, and which surface quality is to be achieved (roughness) and which tolerances are to be adhered to.

In addition, a component, preferably one or more feature groups of the component, may in particular be assigned operating data of the production system, wherein operating data of the production system are in particular data which are or have been detected during the operation of the production system and/or which are suitable for characterising the operation of the production system.

Operating data that are or will be assigned to a component may be data detected and/or determined in particular during the manufacture and/or processing of the component or a comparable component. Operating data are, in particular, data on process parameters, consumption variables, error messages, throughput times, set-up times, downtimes, chip sizes, tolerances or similar detected during operation of the production system. The operating data assigned to a component and/or one or more feature groups may be updated and/or supplemented continuously or periodically (cyclically or acyclically). This enables particularly good control of the production system, in particular almost real-time adaptation of the production system (assuming a sufficient update frequency).

The operating data is preferably detected in a step a2), which may be carried out before, in parallel and/or after step a1) and/or at least partially overlapping with it in time, and assigned to at least one feature group, whereby the detected operating data of the production system in particular become feature group data. This enables particularly advantageous operation of the production system, in particular particularly advantageous optimisation and/or control of the production system.

Operating data may also be: Optical information (images/videos of the component or a feature group during or after machining, images/videos of the machining process and/or of one or more operating resources, tools, clamping devices or similar (e.g. one or more images of a tool cutting edge for an optical wear test before and after machining), the signal curve of one or more control signals, the power consumption and/or energy requirement of one or more machines, machine temperatures, error messages, chip sizes (volume, shape (flow chip, shear chip, tear chip, etc.)), as described, for example, at https://de.wikipedia.org/wiki/Span_(Fertigungstechnik), last accessed on 17 Oct. 2023, material consumption (e.g. of auxiliary materials, oil, coolant), amount of work, cutting values (in particular in connection with a machining tool and/or wear resistance, temperature, achievable quality), tool data (e.g. of machining tools and/or test tools, their suitability for machining component materials as well as their material and properties, data on wear resistance and/or wear condition, tool temperatures, quality achievable with a tool, maintenance data), sensor data (for detecting vibrations, for example from the tool and/or holder system, main spindle and/or machine dynamics) as well as forces occurring during operation (cutting and clamping) and tolerances achieved, wherein this is only an exemplary, non-exhaustive and therefore non-exhaustive list. Other variables not explicitly mentioned here may also be operating data and fulfil the above-mentioned general definition of the term “operating data”.

Operating data that may be used to characterise and/or assess a welding process, for example, are in particular: Temperature, wire feed, gap width, electrode force, speed, current, voltage, power, wire consumption, gas consumption and welding time.

Operating data that may be used to characterise and/or assess a laser cutting process, for example, are in particular: Frequency, laser pulses per second, power, speed, blowing, Z-offset and the passage.

Operating data that may be used to characterise a waterjet cutting process, for example, are in particular: Feed rate, blasting speed, cutting width, blasting power, pressure.

Relevant operating data for characterising or assessing a bending process are in particular: the selection of the production equipment (especially its dimensions (length, width, sheet thickness, bending force and rigidity), the selection of the die and the so-called K-factor (see https://de.wikipedia.org/wiki/Biegeverk%C3%BCrzung#Korrektur_durch_den_sog._k-Faktor, last accessed on 17 Oct. 2023).

The operating data may also include or be key figures that are or have been determined based on one or more detected operating variables, such as production key figures such as plant availability, mean time between failures, plant efficiency, set-up time percentage, production output, reject rate, production error rate and throughput time or overall equipment efficiency, as described at https://wiki.hslu.ch/controlling/Produktionskennzahlen, last accessed on 17 Oct. 2023, or comparable key figures.

In particular, the data assigned to a component are at least partially summarised into so-called feature groups, i.e. groups of features, wherein at least one feature group is assigned to the component in particular. For example, all data that are assigned to a specific hole, such as “Hole 1”, in a workpiece may be summarised in the “Hole 1” feature group. For example, the nominal diameter of the hole, the hole depth, shape and position tolerances of this hole, surface qualities in various inner surfaces of the hole, etc., an alphanumeric identification name and/or an object colour that may be interpreted by the workstation and/or other identification attributes, i.e. associated feature group data, may be summarised for a feature group of the type “hole”, and assigned to one or more components via the associated feature group, here a feature group “Hole”, for example feature group “Hole 1”.

It is particularly advantageous if each component that may be processed within the production system and which comprises a corresponding feature group with the associated data is assigned to this feature group or this feature group is assigned to the component.

In particular, if many components within a production system have one or more identical feature groups, a high degree of standardisation may be easily achieved by assigning feature groups to components in this way. When changes are made, only the data for each feature group need to be changed, but no longer for each component. This considerably reduces the amount of changes required and thus significantly improves a production system. In particular, simpler operation of the production system may be realised. Above all, the updating effort may be reduced. Furthermore, less memory is required to save the changes. In addition, version control may be simplified and revision security increased.

For example, features and their associated data may be grouped on the basis of so-called geometric shape elements, i.e. in particular on the basis of geometric shapes, which in particular represent basic geometric bodies or standard shapes.

For example, data and/or features that define a cylinder may be grouped into a “cylinder” feature group. The associated data that define or characterise a feature group are known as “feature group data”.

Exemplary shape elements, which may form particularly advantageous feature groups, may be, for example: Cylinders or cylindrical sections, bores, flat surfaces, chamfers, circles, pitch circles, spheres, spherical sections-in each case positive or negative, i.e. formed as a recess or in solid material-grooves, cubes, cuboids and/or prisms.

For example, a hole 1 may be assigned a nominal diameter 1 with a hole depth 1 and shape and position tolerances XY and/or an attribute for unambiguous identification and/or recognition of the shape element.

The provision of data in step a1) of a method according to the invention comprises in particular the provision of data containing information on one or more feature groups and/or assigned to one or more components. The data may either only contain information about which feature group(s) is/are assigned to the component and/or information, i.e. data, which at least partially define the features of the group and/or the component directly. I.e. for step a1) it is generally sufficient if only or at least partially only data are provided, on the basis of which, for example, it may only be determined which components that may be processed in a production system are all assigned to a certain feature group, for example the feature group “bore” or “cylinder”, but on the basis of which it cannot be determined how exactly the feature group is defined. In the case of an engine block, for example, this could be data indicating that the engine block 4 has cylindrical bores in the “cylinder bore” feature group, without the data already specifying the cylinder bore precisely in this step.

This information on how the cylinder bore is defined, i.e. exact feature group data, such as nominal diameter, tolerances, surface finishes, honing process parameters, possibly further associated machining processes and/or associated inspection process(es) at a workstation (CAM, CAQ) and/or as mentioned above, may also be provided later if required, for example only for, with or in step c), if this information is required for an evaluation, wherein in this case in particular only the feature group data of the selected feature group(s) are provided and not for feature groups beyond this. This means that considerably less data need to be provided for the provision of the feature group data in step c), which may save data streams, storage requirements, network resources, computing power and other resources.

Providing the data may in particular comprise reading data from a memory, in particular from a computer-readable memory, capturing data, collecting data, generating data and/or entering data, as well as a combination thereof.

In particular, the detection of data may take place in a separate step before, after and/or at least temporarily at the same time as the provision, in particular using one or more sensor devices.

Before the corresponding data are provided, especially if stored, saved or detected data are provided, it is possible to first check whether the available data intended for provision are already assigned to one or more components. If this is not the case, the available data, or at least part of this data, may be assigned to one or more components and/or feature groups.

The available data may be at least partially assigned to one or more components and/or one or more feature groups. In particular, the data may contain information on one or more feature groups and/or components.

In some cases, it may be advantageous if the respective data are not assigned directly to one or more components, but only indirectly to a component via one or more feature groups. This has the advantage that no redundant assignments have to be kept, but the data are only assigned to one associated feature group, for example, and only the feature group is assigned to the component, but not the data, and the feature groups are each assigned directly to the component. This may significantly reduce the amount of information to be stored or kept available, particularly in the case of a large number of components that may be processed within a production system, but a large number of which have one or more identical feature groups. Furthermore, in many cases this may reduce the error rate, improve process reliability, improve data consistency, up-to-dateness and quality, increase the standardisation rate, increase revision security, accelerate automation via the workstations or improve data version control and, as a result, reduce costs, increase transparency regarding costs and the required capacities and thus generally optimise the production system and its operation.

“Feature group data” in the sense of the present invention are accordingly data which are assigned to at least one feature group and which contain at least part of the information for defining the feature group(s).

Using the example of a geometric shape element “hole”, feature group data may be, for example, geometric data such as nominal diameter and hole depth. In addition to geometry data, however, feature group data may also, as explained above in connection with data in general, primarily be operating data, in particular production data and/or test and measurement program data. In particular, feature group data may be any type of attribute that may be assigned to a feature group, such as machine parameters for manufacturing the component, identification data, coordinate measurement reference data, etc.

In particular, the feature group data of a feature group may be individual or all data that may define and/or characterise the feature group or the features combined into a group.

Feature groups do not have to be pure component-related groups of features or geometrically sensibly combined features to form a group, but feature groups may also be groups of completely different features. A feature group may also be a combination of feature groups, in particular of different feature groups. The properties of a component may also be defined by various combinations of feature groups, for example by geometric addition or subtraction or swipes or the like of feature groups. In particular, a feature group may be a group of features that comprises, on the one hand, features of a geometric shape element and, on the other hand, features that are based on the detected operating data, such as a throughput time, a reject rate and/or costs, which define and/or characterise other aspects of a component or the production system. Feature group data may in particular be CAM data, CAQ data and/or CMM data and/or operating data of the production system.

A feature group may also be a group of features that comprises several feature subgroups, such as a feature group “bore”, which may comprise a wide variety of bores, in particular bores with different nominal diameters, wherein the bores with different nominal diameters may each represent individual feature subgroups. A feature group and/or one or more feature subgroups may alternatively or additionally be assigned to a workstation (CAx), for example on the basis of a revision status and/or identification by means of an ID number.

For example, groups of features have proven to be advantageous, each comprising features that characterise or define at least one geometric shape element, as well as further features assigned to at least one geometric shape element, which are based in particular on operating data, such as costs, throughput time and reject rate and/or features that characterise the manufacturing process or one or more manufacturing steps and/or one or more testing processes. In particular, the feature groups “geometric shape element”, “geometric shape element and costs”, “geometric shape element and throughput time”, “geometric shape element and reject rate”, “geometric shape element and tool” and “revision status of the geometric shape element” have proven to be advantageous with regard to improving the control of a production system, in particular with regard to improving the operation of a production system according to the invention, preferably with regard to optimising a production system.

If data are available, in particular data which are assigned to one or more components and/or feature group data, but there is still no assignment of feature groups to one or more components or, conversely, no assignment of at least one feature group to each component, a method according to the invention may in particular additionally comprise an assignment step which is preferably carried out or takes place before the data are provided in step a1), wherein in this assignment step in particular at least one feature group is assigned to each component.

In an advantageous embodiment of a method according to the invention, this may in particular be carried out at least partially automatically, in particular with the aid of corresponding, predefined reference feature groups which may be compared with the component, and if there is a sufficient match, the component is assigned a corresponding feature group, in particular a predefined and/or stored feature group or a newly created or newly to be created feature group, depending on the reference feature group with which an at least partial match has been determined.

A fully automated assignment is also conceivable, but a semi-automated assignment still allows manual control of the assignment. Fully automated allocation, on the other hand, enables faster allocation and the avoidance of human error as well as allocation independent of working hours, which in particular enables efficient allocation outside of a production plant with few personnel, for example at weekends or at night,

For the purposes of the present invention, the term “manual” means, in particular, the performance of individual actions and/or method steps by a user, operator, machine operator or the like.

“Partially automated” in the sense of the present invention accordingly means a process in which individual process steps are carried out manually, i.e. by a user, operator or the like, and individual process steps are carried out with the aid of a corresponding computer device, automation device or the like, in particular with the aid of a computer and/or a data processing device.

Accordingly, “fully automated” means carrying out a process or process step without manual steps.

Manual steps or procedural actions in this context may be, in particular, entering data, checking and/or releasing data, confirming actions, starting and/or ending and/or linking data with each other or similar.

The selection of at least one feature group in step b) is carried out in particular according to defined criteria, preferably according to predefined criteria. A corresponding criterion may be, for example, the frequency of a criterion, such as the frequency of occurrence of a feature group per se or the frequency of occurrence of a shape element across all components that may be manufactured in a production system. Or the frequency of occurrence or production of a certain shape element in a defined period of time. Or the error rate of the individual feature groups, wherein in particular the feature group with the highest error rate may be selected. Beside the aforementioned criteria, selection may also be based on other criteria, such as quantity (pure frequency), robustness or the reject rate, or a combination of criteria, such as quantity x process time. It is particularly advantageous if the feature group that most frequently fulfils this criterion is selected.

In a possible embodiment of a method according to the present invention, the feature group to be selected in step b) may be selected from all feature groups assigned to the provided data or with which the provided data are associated, or only from a part of these feature groups. This means that filtering may be carried out between the provisioning and selection steps if required.

For example, the set of all feature groups from which a feature group is to be selected may be the set of all feature groups of a component, of several components, or only of selected components that may be manufactured in a production system. Alternatively or additionally, the set of all feature groups from which at least one feature group is to be selected may comprise a set of feature groups with one or more identical properties, for example with one or more identical routings and/or steps and/or one or more identical CAx data sets, such as a common CAD model, a common CAM setup and/or a common CMM setup.

The data assigned to a component may in particular be feature group data and be assigned to at least one feature group, wherein feature group data are in particular only necessarily linked to the feature group in each case, but do not necessarily have to be directly linked to an associated component that is linked to the associated feature group.

Feature group data may alternatively or also be data that are directly assigned to a component, in particular the component to which the associated feature group is assigned. Not all data that are directly assigned to a component necessarily has to be feature group data. It is also possible for data to be assigned to a component that is not assigned to a feature group. These may be, for example, part numbers, identification numbers or similar.

Feature groups may also exist or be defined and thus be selectable, in particular one or more associated shape elements to which no machining process or step is assigned. These may be areas on a component that are not processed, for example. This means that the surface of the raw part and the finished part are identical and are not subject to any process.

After selection in step b), at least some of the feature group data assigned to the at least one selected feature group are provided in step c). Provisioning may also take place in this step by reading from a memory, generating, detecting, retrieving or the like.

If the feature group data of the at least one selected feature group are provided, it is analysed in step d) and at least one value of at least one variable characteristic of the feature group is determined. Such a value may be, for example, the average value of a throughput time of a defined geometric shape element and or an average feed rate actually achieved by a milling machine for milling the contour of a geometric shape element, in particular during roughing. However, such a value may also be, for example, an average reject rate achieved as a result of an unachieved surface quality of a flat surface to be polished or similar.

A “characteristic variable” for a selected feature group is understood in particular to be a variable with which the feature group may be at least partially characterised. It does not have to be a variable that only allows conclusions to be drawn about the geometric properties of the component or dimensions, but may be any variable that may be related to the feature group of a component. However, the characteristic variable is particularly preferably a variable that in particular allows conclusions to be drawn about at least one process step in the manufacture of the associated feature group in a production system. Once the characteristic variable has been determined, it is stored, output and/or further processed in step e), in particular using a computer and/or a data processing device.

A characteristic variable may be, for example: a frequency of occurrence of a feature group(s) in the components of the production system or across all or one or more selected workstations, a defined (target process duration) or an actual process duration (actual process duration) and/or these cumulated individually or combined over the frequency of the feature group(s) and/or the associated costs.

A characteristic variable may also be a revision history over a defined period of time, a current revision status, a degree of maturity and/or a physical or economic variable.

Furthermore, every change to a feature group or the associated feature group data is preferably subject to a revision history, given via the revision status, which defines both the degree of maturity in the product creation process and the associated economic and physical variables, which are provided via the feature group data, over time.

In particular, the outputting may comprise displaying on a display or another display device and/or the outputting of a warning tone or signal tone or the like and/or voice information.

In particular, further processing may include at least one generation of a signal, for example a control signal for controlling at least one machine at at least one workstation and/or a data signal with data information for transmission to one or more workstations. A data signal may, for example, be a signal that includes data information about the time of the last change to the feature group or at least one parameter value of the feature group data. This data signal may be used, for example, to ensure that no processing operation is carried out at a manufacturing station if a processing programme is based on older data than an associated feature group that is to be processed at this workstation.

Further processing may alternatively or additionally include, in particular, checking the determined value, for example checking whether this value is within a defined limit range and/or exceeds or falls below a defined threshold value. In this case, further processing may include, for example, the generation of a blocking signal that the production of components is blocked to which the feature group from which the feature group data have been evaluated has been assigned and for which a characteristic value outside a permissible limit range has been determined is only permitted after a separate check and/or until a release has been carried out by an authorised body. For example, corresponding machine programs for processing the component, which include the respective associated feature group, may be blocked until corresponding changes have been made to the component and/or feature group data by the construction area or one of the other workstations and these have been manually released, in particular by an authorised department or person.

This makes it easy to achieve data consistency and quality across the entire production system. In particular, this makes it possible to ensure that the correct data are always available for a processing operation at a workstation, for example. In particular, this reduces production errors and consequently the reject rate.

In particular, further processing may comprise generating and/or outputting and/or displaying and/or transmitting one or more control signals for manual, semi-automated and/or automated fully automated control of a production system as a function of the at least one value determined in step d).

An advantageous embodiment of a production system according to the invention may further comprise a control step for manual, partially automated and/or automated fully automated control of the production system, which is carried out in particular as a function of the at least one value determined in step d).

For this purpose, in an advantageous embodiment of a method according to the present invention, in step e) in particular at least one determined value may be output, which is used in a further step of the method, in particular for controlling the production system.

In the present case, the term “control” in particular does not include “control” per se, but also the initiation of a change to at least one control parameter and/or a change to at least one other parameter of the production system. This alone may lead to an advantageous optimisation of the production system.

Control parameters are, in particular, parameters which may be used to influence the processing result of one or more components and/or influence one or more operating parameters of the production system, wherein a change in a control parameter is reflected in particular in a change in the operating data, in particular in a change in one or more operating variables of the production system, or should at least be reflected in the near future.

In addition to at least one workstation, a production system may in particular also comprise at least one production data management system (PDMS), in particular a central PDMS, with the aid of which the data may in particular be provided centrally, wherein the data may in particular be received by the PDMS and may be sent by it to one or more workstations.

In particular, a PDMS may comprise at least one data memory. At least one data storage device may be a cloud data storage device. This enables a flexible architecture of a production system in a simple way.

As an alternative or in addition to centralised storage in the PDMS, the data may also be stored directly in a production planning and control system of the production system.

A production system according to the present invention is preferably set up in particular to exchange the data by wire or wirelessly between the individual workstations and/or the production data management system.

In one possible embodiment of a method according to the present invention, in particular at least one method step is carried out with the aid of a data processing device and/or with the aid of a computer system.

A corresponding data processing device and/or a corresponding computer system may in particular be integrated into one of the workstations and/or several of the workstations and/or into the production data management system, but is (data) communication-connected or (data) communication-connectable to at least one of these units.

All steps of a method according to the present invention may be repeated once or several times. If technically reasonable and possible, the individual method steps described herein may also be carried out in a different sequence and/or individual method steps may be carried out again before or after.

In an advantageous embodiment of a method according to the present invention, steps c), d) and e) are carried out in the order described above, i.e. first c), then d) and then e).

However, depending on the embodiment of a production system, it may be advantageous in some cases to carry out steps c), d) and e) in a different order, in particular in a second or further cycle, for example after the steps have been carried out once in the order a1) to e) in a first cycle. This means that the prescribed procedure may also be applied iteratively.

In a second cycle in particular, for example, feature group data for several selected feature groups may first be provided and analysed, and then one or a few feature groups may be selected on the basis of the feature group data provided, for example the most frequently occurring feature group or the five most frequently occurring feature groups.

In particular, the method may be used to control operation of the computer-aided production system, wherein it may be configured for manual control of the production system, for semi-automated control of the production system, for fully automated control of the production system or for a combination thereof.

For a particularly advantageous result of a method according to the invention or for a particularly advantageous production system, at least one feature group is a group of features relating to a geometric shape element or a group of features having features relating to a geometric shape element, wherein the associated feature group data characterise and/or define the shape element.

It has been shown that almost every component may be defined almost completely by one or more geometric shape elements and their associated data. This allows components to be summarised according to shape elements. If machining data and/or operating data, for example machine programs such as NC programs for manufacturing these shape elements, are assigned to the shape elements, i.e. the respective “shape element . . . ” feature groups, standardisation, adaptation, modification and data consistency may be achieved across many components with little effort.

In a possible embodiment of a method according to the present invention, at least one feature group, in particular each feature group, therefore has at least one geometric shape element, in particular a geometric base body, and/or at least one feature dependent on a geometric shape element, wherein the associated feature group data contain in particular operating data, preferably geometry and/or production data and/or test and/or measurement (program) data relating to the at least one geometric shape element. In particular, each shape element may be assigned at least one data set with data on the relative and/or absolute position of the shape element. Alternatively or additionally, operating data are preferably assigned to each shape element. Alternatively or additionally, each feature group, in particular each shape element, may be assigned an ID number for unique identification, in particular for unique identification of the feature groups and feature group data.

A geometric shape element may in particular have or be a bore, an elongated hole, a thread, a stud, a cylinder, a flat surface, a cuboid, a chamfer, a pocket, a cone, a truncated cone, a groove, a sphere, a spherical section, a circle, a circular section or the like, or be at least partially formed or defined from a combination of these.

Feature group data may be, in particular, construction data (geometric data, dimensions, tolerances, weight, material, . . . ), administrative data (order number, part number, . . . ), manufacturing data (feed rate, cutting speed, tool data, NC program, . . . ), production data (actual manufacturing data, throughput times, . . . ), inspection data, cost information, planning data or other data.

A feature group may in particular comprise or be a combination of feature (sub)groups, for example a combination of the feature groups “geometric shape element” and “costs” or “geometric shape element” and “throughput time” or “geometric shape element” and “reject rate”, wherein at least one feature group and/or feature (sub)group in particular always comprises or is a “geometric shape element”, and wherein each feature subgroup in particular is also a feature group and may in particular be selected in step b).

Several feature groups and/or feature subgroups may be assigned to a component, wherein the feature groups and/or feature subgroups are in particular different and/or belong to one and the same main feature group.

A main feature group may, for example, be formed by the geometric shape element “bore” and a sub-feature group may, for example, be a feature group “bore with a defined nominal diameter”. In particular, a feature subgroup is a feature group that comprises at least one parameter and an associated parameter value, which further specifies the feature subgroup in relation to the associated higher-level main feature group. A characteristic subgroup may have further subgroups. A feature group or subgroup may be, for example, a hole, such as a “hole with nominal diameter XY”. This feature group or subgroup may, for example, comprise two (further) feature subgroups, such as “Bore with nominal diameter XY with flat countersink” and “Bore with nominal diameter XY with taper countersink”.

In a further possible embodiment of a method according to the present invention, in particular in an advantageous embodiment, the at least one feature group is selected as a function of a frequency distribution of at least one of the parts of the feature groups and/or according to the frequency of a specific criterion which the individual feature groups fulfil.

A selection depending on the frequency distribution of at least some of the feature groups, each of which is assigned to a geometric shape element or represents a geometric shape element, has proven to be particularly advantageous.

The selection may be made in particular depending on the frequency distribution over all feature groups occurring within a production system or only over a part of the occurring feature groups.

Making the selection based on a frequency distribution has proven to be particularly advantageous for a production system, as the Pareto principle usually applies, according to which approx. 80% of the machining processes in a production system are usually allocated to only approx. 20% of the feature groups or, to put it the other way round, 20% of the feature groups are the basis for 80% of the machining processes or define them. In many production systems, only around 20% of all shape elements within this production system account for around 80% of the machining processes. In other words, if you may identify, and in particular reliably identify, the 20% of shape elements that cause around 80% of the costs, a great deal may be achieved by optimising these 20%. This allows a particularly efficient optimisation of a production system to be achieved.

In this context, however, the question arises as to how the 20% “correct” components may be clearly identified. For this purpose, it has proven to be advantageous to use feature groups and to select one or more feature groups depending on a resulting frequency distribution of the feature groups, wherein in particular the most frequently occurring feature group and possibly further feature groups are selected according to descending frequency, in particular until approximately 20% of all occurring feature groups are covered. These may then be analysed in a further step, in particular their associated feature group data, and appropriate measures may be initiated if necessary.

For a production system, it has proven to be particularly advantageous to use feature groups which comprise at least one geometric shape element and/or contain or group features of a geometric shape element, with associated feature group data which define and/or characterise the respective geometric shape elements. Therefore, the selection may be based in particular on a frequency distribution of feature groups that are based on at least one geometric shape element across some or all of the components processed in the production system.

If all components that are processed within a production system are assigned corresponding feature groups, in particular feature groups based on one or more geometric shape elements, i.e. the component is “broken down” mentally into several of these feature groups or, in particular, each component is composed of one or more feature groups, in particular by construction, the individual feature groups, in particular in this case the individual geometric shape elements, represent the basis, in particular a kind of modular system, for all components to be processed within the production system. Just as the individual words of a language may be put together to form sentences and entire texts, the components may be put together from the feature groups. Similar to language, the individual feature groups or shape elements are found differently often in the individual components and thus, in particular, differently often within the production system. This means that not all of the generally occurring feature groups or, in particular, all geometric shape elements occur equally often, but some more and some less, wherein some of the feature groups occur disproportionately often, similar to the behaviour of the words of a language.

If it is possible to identify the relevant 20% of the feature groups, which account for approx. 80% of the effort or the like of a production system, a particularly efficient optimisation of the product production system and the associated product creation process (PCP) may be achieved, even if at least partially automated.

In particular, the assignment of feature groups to components and to processes within the production system, especially to individual process steps within the product creation process, for example in production planning and/or in production planning and control, especially on the basis of geometric shape elements, may be used to efficiently achieve standardisation across a company's entire range of components.

Standardisation, in turn, enables the efficient collection of operating data and consistent key figures on duration, costs, etc. By means of consistent production data detection and/or generally consistent data collection via the production system, the production system, in particular production planning and control, may be supplied with the determined key figures and the operation and in particular the control of the production system may be continuously improved. This enables a kind of self-administration and self-organisation of the production system, particularly in production planning and control. Furthermore, manufacturing processes that occur frequently, cause high capacities or costs or are unstable or have low process reliability may be identified, filtered out and analysed in this way. On the basis of the evaluation results subsequently obtained for the selected feature groups, in particular of shape element-related feature group data and the key figures (characteristic variables) determined on this basis, such as frequency, throughput times, capacity requirements, costs and rejects, individual processes or process steps of the production system may be optimised by improving/changing the control of the respective process or process step.

In this way, an improvement and/or optimisation may be achieved with little effort, namely based on around 20% of relevant feature groups from a trained set of feature groups for around 80% of the associated feature groups. In particular, a high level of data consistency may be achieved with just a few feature groups, as well as particularly efficient centralised management of all production system data.

In particular, the correct definition of the feature groups is decisive for the selection of the correct, relevant feature groups. This means that the feature groups should be defined in such a way that they have a sufficient, but not too high “resolution” in relation to the component spectrum of the production system. This means that the type and number of feature groups from which a selection may be made, especially depending on their frequency, should be chosen appropriately.

For a production system, it has proven to be particularly advantageous in some cases if the feature groups are selected in such a way that a frequency distribution is achieved that approximates a frequency distribution according to Zipf's law, wherein the most frequently occurring feature group, i.e. the feature group at rank 1, has a frequency of approx. 5-10%, in particular of approx. 7-12%, in particular of approx. 10%. And the other feature groups in the following ranks have a frequency that follows Zipf's law.

The mathematical definition of Zipf's law is as follows: If the elements of a set-for example the words of a text-are ordered according to their frequency, the probability p of their occurrence is inversely proportional to the position n on the frequency list. The place is also called rank:

p(n)=1/n→p(1)/n with n=RANK=1,2, . . . , 100000

Depending on how often the most frequent element (word) occurs, the frequency of all other elements may be estimated using Zipf's distribution function. Let's assume that the most common element occurs with a frequency of 10%: p(1)=10%. You may then determine the frequency of the subsequent ranks.

So you know that:

p(1)=p(1)/1=10% with R=1 RANK 1:

p(2)=p(1)/2=5% with R=2 RANK 2:

p(3)=p(1)/3=3.3% with R=3 Rank 3:
etc. . . .

In a further possible embodiment of a method according to the present invention, the feature group is selected with the aid of Zipf's law based on the determined frequency distribution, wherein a rank is assigned to the feature groups depending on their frequency according to Zipf's law and the feature group is selected depending on its rank, wherein in particular the highest-ranking feature group is selected. Alternatively, the second-highest or a lower-ranking feature group may be selected.

It is particularly advantageous to select the feature groups with the highest frequency, which represent approximately the most frequent 15-30%, especially the most frequent 20%.

The frequency distribution of the individual feature groups should preferably correspond to Zipf's distribution function, as this has been shown to achieve particularly good optimisation results. In other words, the feature group at rank 1 should have a frequency of around 10%, that at rank 2 around 5% and so on.

If, on the other hand, it turns out during the determination and/or frequency distribution of the feature groups that, for example, the feature group at rank 1 occurs with a frequency of 50%, this is in particular an indication that the underlying feature group definition has not been selected appropriately, in particular that it does not have sufficient “resolution”.

In this case, it may be advantageous, for example, to assign at least one additional parameter and corresponding values to the feature group at rank 1 or other feature groups, and, for example, to define feature subgroups and execute a second process cycle and, if necessary, repeat the individual method steps until the frequency distribution approximates Zipf's distribution function. If, for example, the geometric shape element “hole” occurs most frequently (about 50%), it may be useful to define sub-feature groups of the feature group “hole”, for example depending on the respective nominal diameter of the holes, to determine the frequency distribution of the feature groups again with the new feature groups and then to select and analyse the highest-ranking feature groups and, if necessary, to initiate measures. This is the only way to achieve efficient control of the production system. This is because if the analysis/optimisation of the production system were based on all drill holes, too many components would be optimised or too much effort would be required to significantly increase the degree of automation, especially up to “80% automation”. This may achieve the desired optimisation, but possibly with a poorer cost-benefit ratio.

In some cases, it may also be advantageous to choose feature group definitions that approximate an adapted/modified Zipf's distribution function, which may better fit the production system and associated components.

For example, Zipf's distribution function may be adapted to optimise the feature group selection using compression and/or stretching parameters and/or one or more offsets.

In some cases, it may also be advantageous to use a frequency distribution function other than Zipf's distribution function. However, Zipf's distribution function has proven to be particularly advantageous for production systems.

In particular, if only very few feature groups are defined due to the production system and one feature group (the most frequent) has a frequency of more than 20% and a meaningful increase in the “resolution” is not possible due to a lack of corresponding subdivision options, it may be advantageous to use a different distribution function as a basis to which the frequency distribution should approximate. For example, a stretched Zipf's distribution function (using appropriate parameters) or another distribution function may be used in this case. However, a left-distributed frequency distribution seems to be advantageous in any case. Approaches or corresponding frequency distributions according to “Benford's law”, the “Pareto principle”, the “Pareto effect”, the “20/80 rule”, a representation according to “ABC analysis” and/or a representation according to the so-called “top task analysis” are particularly advantageous.

However, it is generally important for a good result that the resolution of the feature groups, on whose frequency distribution the selection is based, is chosen appropriately, which may be checked in particular with a defined frequency distribution, especially with a frequency distribution adapted to the respective production system. In particular through a comparative presentation (comparison plot).

In a further possible embodiment of a method according to the present invention, it is checked, in particular in a further step e), whether the value determined in step d) is within a predefined, permissible value range and/or below or above a defined limit value. This makes it easy to determine whether the production system is working as desired or whether the control of the production system needs to be changed and/or optimised.

One or more permissible value ranges may in particular be predetermined, i.e. in particular be predefined and stored in a memory and read out from it as required, and/or be or have been obtained from detected process data of the production system, i.e. be based on so-called operating data.

In a further possible embodiment of a method according to the present invention, at least one measure is preferably initiated in a further step, in particular in a further step f), preferably as a function of the value of the at least one characteristic variable determined in step d), wherein preferably at least one parameter value is changed, in particular of at least one parameter of the feature group data of the at least one selected feature group. And/or one or more parameters and their associated values are added or removed from the data, in particular from the feature group data of the at least one selected feature group, wherein in particular a value of at least one control parameter for controlling the production system and/or at least one value of another parameter, in particular a component parameter, is changed or added.

In particular, one or more parameters of product definitions (geometric data of one or more components, clamping devices, etc.), manufacturing definitions (manufacturing parameters, machine parameters, operating equipment parameters, etc.), test definitions (test programs, target tolerances, etc.), assembly definitions (assembly sequences, assembly aids, assembly steps, assembly sequences, etc.) as well as planning definitions (selection and definition of planning stages, work plans, work steps, processing sequence, use of the production system for this (which workstation, etc.) and/or maintenance definitions (maintenance measures, maintenance times, etc.) may be adapted, changed and/or added and/or removed. This allows the production system to be customised particularly well and in line with requirements. By advantageously selecting a feature group in accordance with the invention, a significant improvement of the production system may be achieved with little effort, in particular a significant optimisation of its operation (assuming a suitable adaptation/modification/addition/removal of one or more parameters).

In the further course of operation of a production system, the production system is controlled in particular as a function of and/or taking into account the at least one or more parameter(s) changed and/or added in step f).

In particular, a measure is initiated if the test shows that the value determined is outside a permissible range.

If, for example, it is determined that a shape element has a particularly high reject rate, it may be advantageous to change the values of one or more processing parameters at one of the associated manufacturing stations at which the shape element in question is processed (e.g. specify a different tool and/or adjust the feed rate, speed, etc.) or correct any incorrect construction data on which the shape element is based, or check the quality of the component blanks.

If a production system has several similar workstations for processing a shape element, it is easy to determine, for example, whether the reject rate is within a defined tolerance range around the average reject rate across all machines, or is outside of it, and therefore whether the control of the production system should be adjusted to reduce the reject rate of the shape element in question.

In an advantageous embodiment of a method according to the present invention, in a further step c1) at least one parameter value of the provided feature group data is changed and preferably, in particular also in a further step d1), the feature group data of at least some components, preferably of all components to which the feature group with the feature group data is assigned, of which at least one parameter value has been changed, is updated.

Preferably, at least one parameter value is adjusted, preferably as a function of the value determined in step d) of at least one characteristic variable of the feature group, preferably a parameter that is suitable for controlling the production system and in particular in such a way that improved operation of the associated production system may be achieved, in particular optimisation.

In particular, an adaptation may include component optimisation, i.e. an adaptation of the component data, e.g. geometry data, and/or an adaptation of machine/working station data for processing on a manufacturing station. However, an adjustment may also include a change to the production planning, for example a change to the sequence planning, such as moving the processing of a shape element from one processing machine to another.

An added parameter (value) may, for example, be a blocking flag, which indicates or contains information that, for example, shape element XY may no longer be manufactured on machine Z, wherein such a blocking flag may, for example, trigger a blocking of processing on machine Z if a component with the relevant shape element XY inadvertently ends up on machine Z for processing. This may be particularly advantageous in production systems with CAx workstations or CAx machining processes that are downstream of one or more CAD machining stations or steps.

Data to be added may also be new test and measuring program information, for example a new, additional measuring point, an additional tolerance specification or similar.

Process data may also be data that may be added or changed in the form of parameters and associated values, such as, for example, temperature specifications or temperature curves to define temperature control in a machining process.

Physical variables may also be corresponding data (to be added).

In some cases, it may be necessary, for example, to restrict previously freely selectable values of a parameter to a defined, permissible range and/or, for example, to extend or narrow tolerance bands.

In a further possible embodiment of a method according to the present invention, the changed parameter value and/or one or more parameters to be added and their parameter values as well as information about the associated change(s) are stored in a production data management system, in particular centrally. This makes it particularly easy to achieve a reduction in data redundancy, an improvement in data consistency, up-to-dateness and quality, an increase in the standardisation rate, an increase in revision security and an improvement in data version control. Furthermore, centralised data storage and the resulting reduction in data redundancy may reduce the error rate in many cases. This in turn has a favourable effect on process reliability and costs.

In particular, all data, preferably all feature group and component data, may be stored in a production data management system, especially centrally. In principle, however, the data may also be stored decentrally or both, i.e. partly partly (some data centralised, some decentralised). The only important thing is to have the appropriate access. For example, at least some of the data may be stored in a production planning and control system of the production system.

However, if the data assigned to a component and/or a feature group and its changes are stored centrally in a production data management system (PDMS) and if this is linked to the individual workstations, i.e. in particular connected or connectable via data communication, data changes may be realised quickly and without much effort across many components and transmitted to the respective workstations or, conversely, values changed at workstations may be fed back directly to each component via the associated feature group.

In a further possible embodiment of a method according to the present invention, the parameter value and/or one or more parameters to be added and their parameter values as well as information about the associated change(s) is/are changed across all components to which the at least one selected feature group is assigned, wherein the change(s) and/or updates may in particular be performed manually, semi-automatically or fully automatically.

If the data assigned to a component and/or a feature group and its changes are stored centrally in a production data management system (PDMS) and if this is linked to the individual workstations, i.e. in particular connected or connectable via data communication, data changes may be realised quickly and without much effort via the assignment of feature groups to components and transmitted to the respective workstations or, conversely, values changed at workstations may be fed back directly to each component via the associated feature group, as not all components need to be changed, but only the feature group data, the number of which is considerably lower than the number of components. This means that considerably fewer changes are required in terms of numbers. However, significant improvements may also be achieved by storing the data directly in an associated production planning and control system of the production system.

This enables simpler version control and easier tracking of changes. In particular, the resources required to manage the changes (e.g. the memory required) may be significantly reduced.

Furthermore, this approach may be used to determine the maturity level of a component with little effort, in particular within the CAx chain of the associated production system, namely via the respective maturity levels of the feature group(s) assigned to the component. The maturity level of a feature group across one or more workstations or across the entire CIM architecture is defined in each case in particular by the revision status or the version or change status of the feature group, in particular by the revision status or the version or change status of the associated feature group data and may therefore be determined in an advantageous embodiment of a method according to the invention in particular with the aid of the revision status and/or the version and/or change status of some or all of the feature group data of a feature group. In a further possible embodiment of a method according to the present invention, the degree of maturity of the component may also be determined from the degree of maturity of one or more feature groups of a component.

In a further possible embodiment of a method according to the present invention, in particular during operation of the production system, before a work process is started at a workstation of the production system for machining a component, the data provided locally at or in the workstation for machining the component are at least partially compared with the data stored in particular centrally in the production data management system, wherein in the event of a data inconsistency, in particular the work process for machining the component is at least temporarily blocked and/or stopped and/or terminated, in particular until an authorised release takes place, preferably a manual release.

In particular, it is possible to check whether the programs etc. stored at the workstation for processing the component are based on the latest or current data assigned to the component or whether changes made at the workstation for improved processing have been assigned to the component and/or the affected feature group(s) of the component and have been stored in the central production data management system.

If a data inconsistency is detected, a warning may be issued (acoustically and/or by means of a visual display) that the data are not up to date.

If feature groups are also assigned to machine data and/or process data and the individual components via the feature groups, a simple revision control may be realised for these with little effort, especially with few resources, for a part or the entire process chain.

An improvement/optimisation of the operation of a computer-aided production system may already be achieved without the above-described selection of a feature group and the associated evaluation of the associated feature group data if the changed parameter value and/or one or more parameters to be added and their parameter values as well as information about the associated change(s) are stored centrally in a production data management system, and before a work process is started at a workstation of the production system for machining a component, the data provided locally at or in the workstation for machining the component are compared with the data stored centrally in the production data management system, wherein in the event of a data inconsistency, in particular the work process for machining the component is at least temporarily blocked, preferably for all components concerned.

This could be achieved, for example, with a computer-implemented method for controlling the operation of a computer-aided production system, in which the feature group data of a feature group may be updated, in particular at regular intervals, wherein a production system-wide change is or may be proposed in particular after each change to the feature group data made by an operator at a processing station, which change becomes or may become binding throughout the production system after successful, authorised release.

Accordingly, a computer-implemented method, preferably for use in a computer-aided production system, in particular for operating a computer-aided production system and/or for controlling a computer-aided production system, may also comprise only one or more of the following steps:
a1) providing data which may be assigned to one or more components, wherein the data may contain information on two or more feature groups which are assigned to one or more components, wherein at least one feature group may be assigned to each component for which data may be provided, and wherein feature group data may be assigned to each feature group,
a2) detecting operating data of the production system and assigning the detected operating data of the production system to at least one feature group, whereby the detected operating data of the production system may become feature group data,
b) selecting at least one feature group,
c1) changing at least one parameter value, in particular at least one parameter value of the provided feature group data,
d1) updating the feature group data of at least some components, preferably of all components to which the feature group with the feature group data, of which at least one parameter value has been changed, is assigned.

In particular, at least one method step may be carried out with the aid of a data processing device and/or with the aid of a computer system.

This may significantly improve the process reliability of a production system. In particular, this makes it easy to ensure that the latest data are always used.

A computer-aided production system according to the present invention may be characterised in particular by the fact that it is configured and in particular set up to carry out one of the methods described above, wherein the production system may in particular comprise corresponding means for carrying out such a method.

The computer-aided production system may in particular have one or more workstations, wherein the workstations may in particular be networked with one another for communication (wireless and/or wired). A production system may have one or more equal or identical workstations as well as different workstations.

In particular, at least one workstation is configured to process at least a subset of data assigned to a component.

The production system may comprise at least one data processing device and/or at least one computer system.

In particular, a production system according to the present invention may be configured to collect and store production system data during operation.

A production system according to the present invention may in particular be configured to assign production system data, in particular production system data detected during operation, at least partially in a feature group-specific manner or in a feature group-related manner, in particular in a shape element-related manner, and preferably at least partially automated, preferably fully automated.

A production system according to the present invention may in particular be configured to assign production system data detected in connection with the processing of a component, in particular during the processing of a component, to the feature group or feature groups assigned to the component, in particular to shape elements, i.e. to the shape elements assigned to the component, in a feature group-specific and/or feature group-related manner.

In a possible embodiment of a production system according to the present invention, the production system is further configured in particular to at least partially compare the data provided locally at or in the workstation for processing the component with the data stored centrally in the production data management system before starting a work process at a workstation of the production system for processing a component, wherein the production system is further configured in particular to at least temporarily block and/or stop and/or terminate the work process for processing the component in the event of a data inconsistency.

In particular, a computer program according to the present invention may comprise instructions which, when the program is executed by a computer, cause the computer to perform one of the methods described above.

A computer-readable storage medium according to the present invention is, in particular, a computer-readable storage medium on which a computer program is stored, in particular a computer program which comprises instructions which, when the program is executed by a computer, cause the computer to execute one of the methods described above.

A data processing device according to the present invention may in particular be a computer or a control device for a production system according to the invention, wherein the data processing device may comprise means for carrying out a method according to the present invention.

A further aspect of the present invention may be a database, a database structure or a database system, which may in particular be connected in communication with and/or be part of a data processing device as described above, wherein the database comprises in particular data and relations assigned to the data, which are at least partially feature group data and are assigned to at least one feature group, wherein the database is set up for use in a production system as described above and the data and relations are stored in the database in such a way that it is possible to carry out a method as described above using at least some of the data stored in the database.

All the preferred embodiments described herein with reference to the method and their advantages apply correspondingly to a production system according to the invention, a computer program according to the invention, a computer-readable storage medium according to the invention and a data processing device according to the invention and vice versa, insofar as this is technically possible in each case.

Further features of the invention are shown in the claims, the figures and the description of the figures. All features and combinations of features mentioned above in the description as well as the features and combinations of features mentioned below in the description of the figures and/or shown alone in the figures may be used not only in the combination indicated in each case, but also in other combinations or in isolation.

The invention will now be explained in more detail with reference to a preferred exemplary embodiment and with reference to the accompanying drawings.

### BRIEF DESCRIPTION OF THE DRAWINGS

In the drawings:

FIG. 1: shows a schematic representation of an exemplary embodiment of a production system according to the invention

FIG. 2: shows a flow chart with method steps of an exemplary embodiment of a method according to the invention,

FIG. 3: shows a flow chart with further possible method steps of a method according to the invention,

FIG. 4: shows a flow chart with method steps of a further possible, in particular advantageous method for use in a computer-aided production system,

FIG. 5: shows an enlarged view of the reference shape elements or the “bore” and “cuboid” feature groups of the component from FIG. 1,

FIG. 6: shows an exemplary, schematic representation of a possible assignment of feature groups and feature group data to a component with the feature groups in the centre of the figure,

FIG. 7: shows an example of a first frequency distribution of feature groups, in this case geometric shape elements, of components that are processed by an associated production system, determined for a production system,

FIG. 8: shows the frequency distribution from FIG. 7, wherein those geometric shape elements that make up approx. 80% of all shape elements processed in the production system are highlighted,

FIG. 9: shows a schematic representation of the curve of a Zipf distribution, i.e. the curve of a frequency distribution that follows Zipf's law,

FIG. 10: shows a table with the functional variables on which a Zipf frequency distribution is based and their relationship,

FIG. 11 shows example data of a Zipf distribution, wherein the last line represents the cumulative probability of occurrence of the shape elements,

FIG. 12: shows a table with sample data on the frequency distribution of different feature groups, in this case of different geometric shape elements, which are processed in a computer-aided production system, wherein the shape elements are sorted by rank depending on their frequency,

FIG. 13: shows a table for the frequency distribution of sub-shape elements X . . . of shape element X, which are processed in a computer-aided production system, wherein the sub-shape elements are sorted by rank depending on their frequency,

FIG. 14: shows the frequency distribution of the shape elements from FIGS. 7 and 8 with shape elements or feature groups divided into sub-shape elements,

FIG. 15: shows a schematic curve of the frequency distribution from FIG. 14 for the frequency distribution of the feature group “geometric shape element” over the associated geometric shape elements sorted by rank,

FIG. 16: shows a schematic curve of a frequency distribution for the frequency distribution of the feature group “geometric shape element x lead time” over the associated geometric shape elements sorted by rank,

FIG. 17: shows a schematic curve of the frequency distribution from FIG. 14 for the frequency distribution of the feature group “geometric shape element x cost” over the associated geometric shape elements sorted by rank,

FIG. 18: shows a schematic representation for an exemplary embodiment for the interface organisation and for possible data and information flows between different workstations of a production system according to the invention, and

FIG. 19: shows a further schematic representation for an exemplary embodiment of possible data and information flows starting from a feature group reference template (feature group reference data set) to various CAx workstations of a production system according to the invention.

### DESCRIPTION OF PREFERRED EXEMPLARY EMBODIMENTS

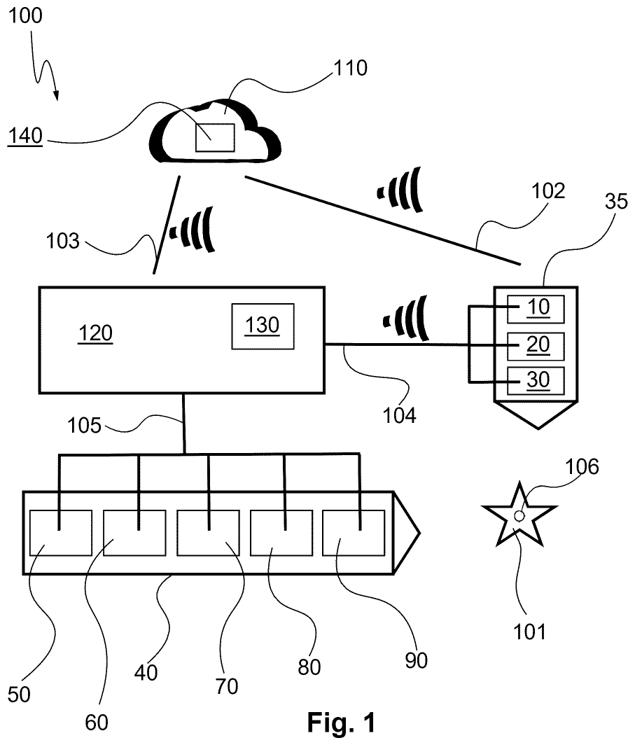

FIG. 1 shows a schematic representation of an exemplary embodiment of a production system 100 according to the invention, wherein the production system 100 according to the invention is configured to carry out a method according to the invention and has a production data management system 120 with a data processing device 130 according to the invention and a data memory 140 located in a cloud 110.

Furthermore, this exemplary embodiment of a production system 100 according to the invention comprises a plurality of workstations 10, 20, 30, 50, 60, 70, 80 and 90, which are in particular each configured to process at least a subset of data assigned to a component 101, which is symbolised in FIG. 1 by a star with a hole 106 in the centre, or to at least partially physically process the component 101.

The component 101 may be, for example, a Christmas candlestick or similar. However, the geometry of the component 101 is not important in the present case. Only one component has been chosen, which allows a simplified, pictorial representation for a better understanding. All features and advantages and the like described in connection with the component 101 are not to be understood as a limitation, but merely as examples for the basic description of the present invention.

Likewise, all of the explanations described in connection with the exemplary embodiment of the production system 100 according to the invention are not to be understood as limiting, but merely as exemplary explanations of the invention. The described production system 100 and the method for operating this production system 100 described in this context are each examples of a possible embodiment based on the present invention.

In this exemplary embodiment of a production system according to the present invention, the workstations 10, 20 and 30 of the production system 100 are each organisationally assigned to production planning and are configured in particular for product-specific processing, wherein the workstation 10 is in particular a CAD workstation, the workstation 20 is in particular a CAM workstation and the workstation 30 is in particular a CAQ workstation. The workstations 50 to 90, on the other hand, are assigned to production planning and control (PPC), which is symbolised by block 40 in FIG. 1, and are configured and set up in particular for order-related processing.

In particular, workstation 50 is a product program planning workstation, workstation 60 is a quantity planning workstation, workstation 70 is a scheduling and capacity planning workstation, workstation 80 is an order monitoring workstation and workstation 90 is an order initiation workstation.

All workstations 10 to 30 and 50 to 90 are each connected to the production data management system 120 or the associated data processing device 130 by data communication, in this exemplary embodiment in particular via a wireless communication link (WLAN) or radio or by other wireless means, which is intended to be symbolised by the connecting lines with the reference signs 104 and 105.

In addition, the individual workstations 10 to 30 and 50 to 90 are also connected to each other for data communication and are also in data communication with the data storage 140 in the cloud 110 via the data communication connections 102 and 103, which are also configured as wireless communication connections in this exemplary embodiment.

This enables efficient and fast data exchange between the individual workstations 10 to 30 and 50 to 90 and thus between all components of the production system 100. This enables a high level of data consistency, rapid provision of up-to-date data at each workstation 10 to 30 and 50 to 90 and therefore optimum processing of the data at the individual workstations 10 to 30 and 50 to 90.

A high level of data integrity and data consistency may be achieved by the central storage of the data in the data memory 140 and the central production data management system 120, via which the workstations are supplied with the respective data or via which data from the workstations may be returned in each case. In particular, the data for each workstation 10 to 30 and 50 to 90 may thus be kept up to date for each component 101 with minimal effort and in near real time, and the current data may thus be provided before each work step at a workstation 10 to 30 and 50 to 90, for example. This may reduce production errors based on incorrect data assigned to a component, thereby reducing the reject rate, optimising the production system and lowering costs.

For particularly efficient operation of a production system 100 according to the invention, the individual components 101 that may be processed within this production system 100 are each assigned one or more feature groups 106. These in turn are each assigned corresponding feature group data, wherein at least one feature group 106, which is assigned to a respective component 101, comprises a group of features for a geometric shape element 106 and in particular comprises or is a feature group 106 of the type “geometric shape element”. This allows a particularly efficient operation of a production system 100 to be realised. This is because it has been established that almost all components 101 may be assembled from several, in particular so-called standard geometry shape elements.

One such example of a geometric shape element that may form a first feature group is, for example, the geometric shape element bore 106 of the component 101. The associated shape element 106 or the associated feature group 106 may be defined by the feature group data assigned to the shape element or the feature group “geometric shape element”.

Corresponding feature group data may be, for example, geometric data such as measurements, dimensions, relative and absolute positions, shape and position tolerances, but also information such as surface qualities, materials or production data, such as process parameters for production such as cutting speeds, feed rates or similar, for example during a machining process, manufacturing aids required for holding, chucks, as well as test programs, plans and points or other quality assurance measures, machine data or information on which machine, for example, the component is to be manufactured, flow charts for defining individual processing steps, etc. In addition, other data such as process parameters such as temperature control sequences, rest times, drying times, maximum permissible throughput times, maximum permissible rest times before further processing, costs, capacity requirements, outline times, cleaning instructions or similar may also be assigned to a feature group.

In this way, most or even all components may be defined in many production systems, in particular via the various feature groups, wherein only the individual feature groups need to be assigned to a component, but not the individual feature group data. Rather, it is sufficient if the individual feature group data are only assigned to the feature groups but the assignment of the individual parameters is not saved separately for each component. As there are considerably fewer feature groups in a production system than there are usually components, the storage requirements for all data relating to the individual components may be significantly reduced and a high degree of standardisation may be achieved easily with minimum effort. However, it is essential that suitable feature groups are assigned to the components and that these in turn are assigned suitable feature group data in order to fully utilise this effect.

A further advantage of this approach is that particularly simple changes and updates of data may be carried out by making a single change to a feature group or the associated feature group data on a large number of components 101, namely on all those components to which the associated, changed feature group 106 is assigned. This may lead to considerable savings in the operation of a production system 100, in particular fewer resources are required for the storage, processing and documentation of changes. In other words, version control, insurance and change management may be considerably simplified. This also makes it easy to extend version control or revision security, as known from the construction area, to all workstations 10 to 30 and 50 to 90 within a production system. In this way, production data, such as machine data and production parameters, which are assigned to a feature group, for example a geometric shape element for its manufacture, may also be assigned to version control and change management together with the geometric data that define the geometry of the respective element. This enables comprehensive and audit-proof data management.

Furthermore, this approach enables particularly efficient operation and, in a particularly simple manner, advantageous, in particular improved control and/or optimisation of a production system configured according to this approach.

A particularly advantageous operation or a particularly advantageous control of a production system according to the invention may be achieved, for example, according to a method according to the present invention.

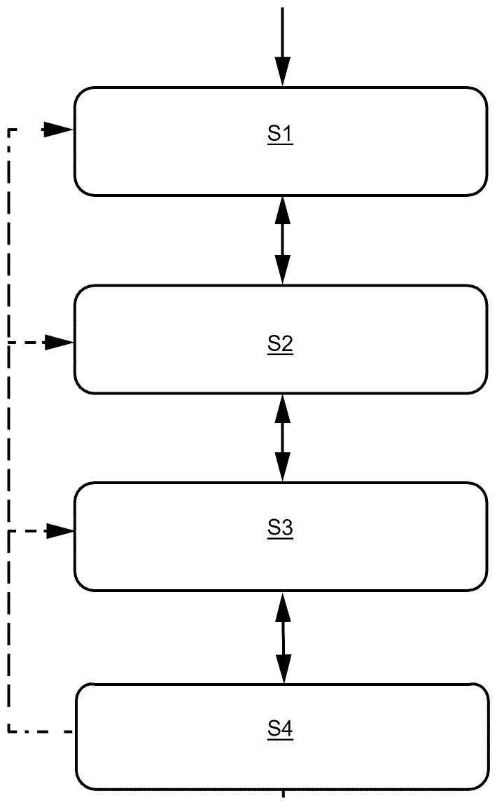

FIG. 2 shows a flow diagram with the first four method steps S1 to S4 of an exemplary embodiment of a method according to the invention for use in a computer-aided production system, such as a production system 100, in particular for controlling an operation of the computer-aided production system 100.

FIG. 3 shows a flow diagram with further possible method steps of a method according to the invention, which immediately follow in this exemplary embodiment. The exemplary embodiment of a method according to the present invention described herein comprises in particular at least the following steps:
S1: a1) providing component data assigned to one or more components 101 that may be processed by the computer-aided production system 100, wherein the component data include information on two or more feature groups 106 each assigned to one or more components 101, wherein each component 101, for which data are provided is assigned at least one feature group, wherein a feature group 106 in each case comprises a group of features which at least partially define the component 101 to which the feature group is assigned, and wherein feature group data is assigned to each feature group 106, and
   a2) detecting operating data of the production system 100 and assigning the detected operating data of the production system 100 to at least one feature group 106, whereby the detected operating data of the production system 100 become feature group data,
S2: b) selecting at least one feature group 106,
S3: c) providing at least a portion of the feature group data assigned to the at least one selected feature group 106, wherein the provided feature group data include at least a portion of the operational data of the production system 100 captured in step S1 and assigned to the feature group 106,
S4: d) analysing the provided feature group data and determining a value of at least one variable characteristic of the selected feature group, i.e., the value of a key figure for the selected feature group,
S5: e) storing, outputting and/or further processing the at least one value determined in step d),
S6: f) initiating at least one measure depending on the value of the at least one characteristic variable determined in step d), wherein at least one parameter value of at least one parameter of the feature group data of the at least one selected feature group is changed and/or one or more parameters and their associated values are added to the feature group data of the at least one selected feature group, wherein in particular a value of at least one control parameter for controlling the production system and/or at least one value of a component parameter is changed or added,
S7: g) storing the changed parameter value(s) and/or the added parameter(s) and their parameter values and information about the associated change(s) centrally in a production data management system; and
S8: h) checking a data consistency during an operation of the production system, in particular before a start of a work process at a workstation of the production system for processing a component, wherein for this purpose the data provided locally at or in the workstation for processing the component are at least partially compared with the data stored centrally in the production data management system, wherein in the event of a data inconsistency the work process for processing the component is at least temporarily blocked and/or stopped and/or terminated and/or updated manually, semi-automatically or fully automatically.

With reference to the production system 100 of FIG. 1, in step a1) or S1, data assigned to the component 101 and other components not shown here are provided, which contain information on at least the feature group 106 (“geometric shape element hole”) and at least one other feature group, in particular on other geometric shape elements, for example triangular shape elements, by means of which the tips of the star of the component 101 are defined in each case, wherein these shape elements are also assigned to detected operating data, such as production parameters such as cutting speeds and parameters, which have been detected during the production of a component with this shape element.

Based on this data, a feature group is selected in step S2 (b)) from the set of all feature groups for this data, wherein the most frequently occurring feature group is selected here in a particularly advantageous embodiment of a method.

The respective feature groups are each assigned a group of features that at least partially define the component 101, wherein corresponding feature group data are assigned to each feature group. For example, a nominal diameter, a hole depth and corresponding process parameters for the associated drilling machine are assigned to feature group 106 “geometric shape element hole”, which define how the hole is to be produced, how the workpiece is to be clamped with which production aids, with which tool the hole is to be produced and how, for example, the hole is to be checked afterwards with regard to its dimensional accuracy and shape and position tolerances. Alternatively or additionally, this may also include the provision of a machining program, for example an NC program, for the machining and/or production of the bore and/or the creation of a test process. The processing programme and/or the inspection process may also be generated and created manually, semi-automatically or fully automatically, wherein in one possible embodiment the processing programme and/or the inspection process may be generated and/or created based on one or more already known processing programmes and/or inspection processes of the associated feature group or one or more comparable feature groups. If a comparable feature group is used as the basis for this, it may be particularly advantageous to select the feature group from the comparable feature groups that has the highest frequency, i.e. occurs most frequently.

After the data for the feature groups 106 assigned to the component 101 and other feature groups have been provided, at least one feature group is selected from the feature groups for which data have been provided and the associated feature group data are provided (step (b) or S2).

The selection of the feature group in step b) or S2 is carried out in particular as a function of a frequency distribution of the feature groups, in particular according to the frequency of a specific criterion, wherein in particular the feature group occurring most frequently for this criterion is selected.

In a further step, the respective feature group data are provided (step S3 or c)) and then analysed (step d) or S4) and at least one variable characteristic of the selected feature group, i.e. in particular a key figure characteristic of the feature group, for example a reject rate, is determined.

In a further step S5 or e), the determined characteristic variable is stored in this exemplary embodiment of a method according to the invention, in particular in the data memory 140 in the cloud 110, output and further processed.

The output takes place in particular by displaying the determined key figure or the value of determined characteristic variable on a display device or reproducing it by means of a display device.

During further processing, the data processing device 130 checks whether the value determined in step d) or S4 is within a permissible limit range.

If not, a corresponding measure is initiated in step S6 or f), in particular at least one parameter value of the associated feature group data is changed and/or added in order to adapt, in particular improve, the operation of the production system, in particular the control of the production system. For example, one or more process parameters and/or machine tool control parameters of a machine tool may be changed if a reject rate of an associated production step on a machine tool for a machining process during the machining of a shape element is above a permissible limit value.

In a further step S7 or h), the changed or added parameter value(s) are stored, in particular in the data memory 140 centrally in the cloud 110, in particular together with information about the associated change(s).

Furthermore, for a particularly advantageous operation of the production system 100, further a data consistency is also checked during an operation of the production system in step S8 or h) before a start of a work process at one of the workstations 10 to 30 or 50 to 90 of the shape element 106 for processing the shape element 106, wherein for this purpose the data provided locally at or in the workstation 10 to 30 or 50 to 90 for processing the shape element 106 are at least partially compared with the centrally stored data, wherein in the event of a data inconsistency the work process for processing the shape element 106 is at least temporarily blocked and/or terminated.

Let us assume that feature group 106 (“geometric shape element hole”) is the most frequently occurring feature group from the feature groups for which data were provided in step a) or S1. Once this feature group 106 has been selected, the associated feature group data are evaluated and analysed.

A characteristic value may be, for example, the reject rate of the last 4 weeks. One result of this analysis may be, for example, that in the production of the bore 106, i.e. in the production of the geometric shape element bore 106, a current, determined reject rate of the production of the last 4 weeks, which may be determined, for example, from the operating data detected and assigned to the shape element, is 10%, but the average reject rate of the last year was 5%.

If a maximum reject rate of 7%, for example, is permitted, appropriate measures are initiated to reduce the reject rate again. In particular, the control of the production system 100 is adapted, wherein at least one control variable is adapted or changed, i.e. a parameter for controlling the production system, which in particular has an effect on the reject rate of the associated feature group “shape element bore” 106. For example, a cutting speed, a selected tool, a feed rate or similar may be adjusted.

The change is saved centrally and distributed to all affected workstations on which the shape element 106 is processed within the production system.

Before a work process is started at one of the workstations 10 to 30 or 50 to 90 of the for processing the shape element 106, a data consistency is checked in each case, wherein the data provided locally at or in the workstation 10 to 30 or 50 to 90 for processing the feature group 106 are at least partially compared with the centrally stored data for this purpose, wherein the work process for processing the shape element 106 is at least temporarily blocked and/or stopped and/or terminated in the event of a data inconsistency.

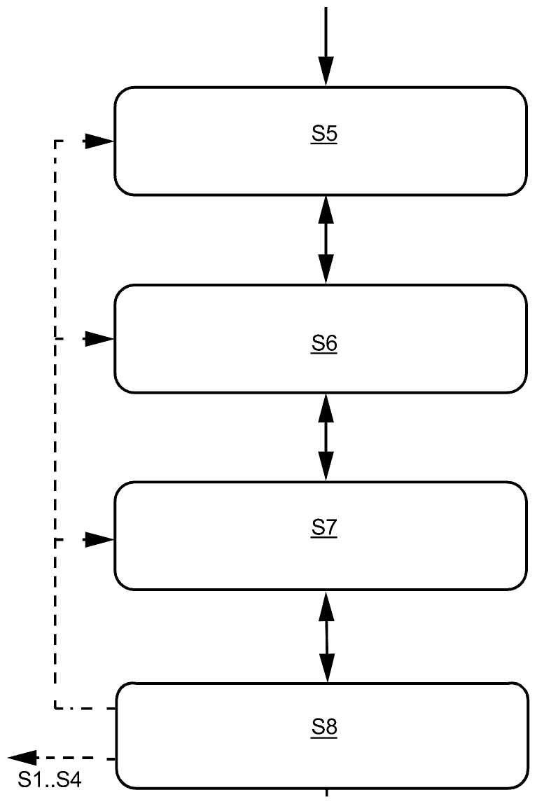

FIG. 4 shows a flow chart with method steps of a further possible, in particular advantageous process for use in a computer-aided production system, wherein this example of an advantageous process for a production system comprises the following steps, which may be carried out in particular in addition to or as an alternative to a method according to the invention:

S1A: a1) providing data assigned to one or more components 101, wherein the data include information on two or more feature groups 106, each assigned to one or more components 101, wherein at least one feature group 106 is assigned to each component 101 for which data are provided, wherein a feature group 106 comprises a respective group of features which at least partially define the component 101 to which the feature group 106 is associated, and wherein feature group data are assigned to each feature group 106,

S2A: b) selecting at least one feature group 106,

S3A: c1) changing at least one parameter value of the provided feature group data,

S4A: d1) updating the feature group data of at least some components 101, preferably of all components to which the feature group 106 with the feature group data is assigned, of which at least one parameter value has been changed.

These method steps enable a particularly efficient implementation of changes, in particular an efficient and revision-or version-controlled implementation and documentation of changes to a large number of components with little change effort and little memory requirement, since the changes only have to be made to the associated feature group 106, but not to each component 101.

In the production system 100, the method steps described above are each carried out with the aid of the data processing device 130.

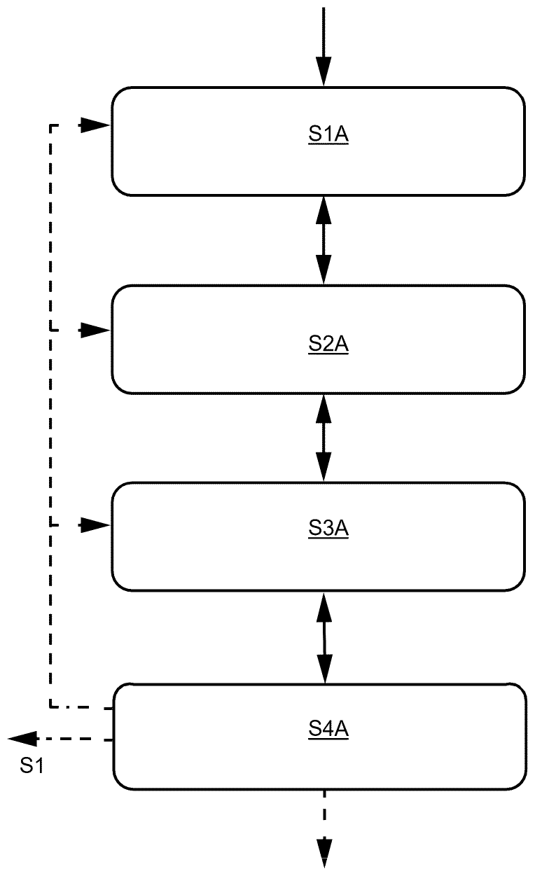

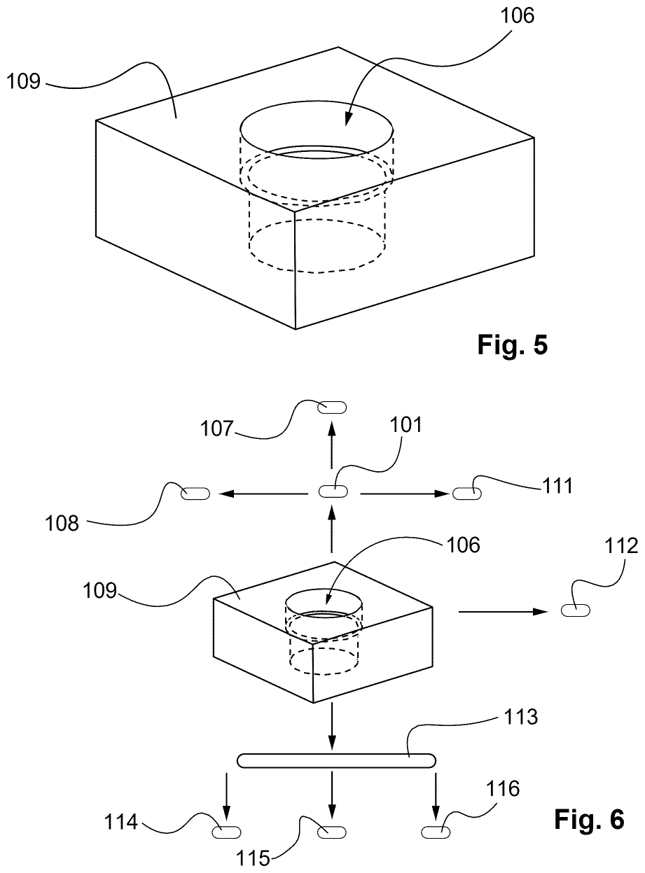

FIG. 5 shows the reference shape elements or the feature groups “bore” and “cuboid” of the component from FIG. 1 in an enlarged representation, wherein the component 101 is also assigned in particular a second feature group 109 “geometric shape element cuboid” in addition to the first feature group 106 “geometric shape element bore”. The geometric combination of these feature groups 106 and 109, in particular the geometric subtraction of 106 from 109, produces component 101.

FIG. 6 shows an exemplary, schematic representation of a possible assignment of feature group data to feature groups 106, 109 or a combination of feature groups and/or to a component 101. In addition to feature groups 106, 109, which comprise or represent geometric shape elements, other feature groups and feature group data may also be assigned to the component, such as feature groups with feature group data of category 107 (“Components/year”), 108 (“Number/type of feature groups”), 111 (“Material”), 112 (“Key figures/KPIs”) and other categories in the form of main categories and subcategories 113 (main category “Testing and production process data”), 114 (subcategory “Production equipment and production aids”), 115 (subcategory “Strategy/production organisation”) and 116 (subcategory “Testing and production parameters”).

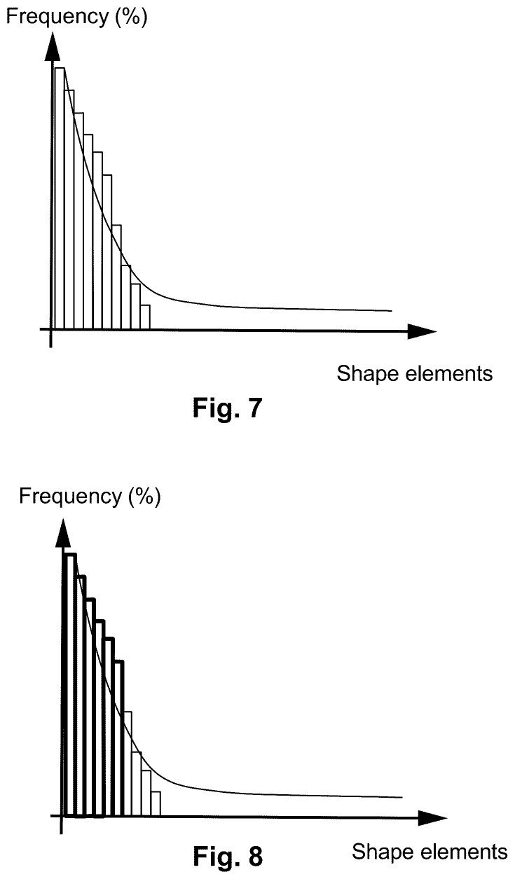

FIG. 7 shows an example of a first frequency distribution, determined for the production system 100, of feature groups, in this case geometric shape elements, of components which are processed by the associated production system 100, wherein the most frequent feature group is of the “bore” type and in particular accounts for approximately 50% of all feature groups.

FIG. 8 shows the frequency distribution from FIG. 7, wherein those geometric shape elements that make up approx. 80% of all shape elements processed in the production system are highlighted.

Optimisation of the most frequent feature group would therefore affect more than the 20% that are only sought to be optimised in order to adapt the production system as efficiently as possible. It is therefore necessary to change the feature group definitions in order to obtain a more suitable “resolution” of the feature groups. For this purpose, the method steps S1 to S8 according to the invention are repeated iteratively in particular until a frequency distribution of the feature groups is obtained, which in particular approximates a Zipf distribution function.

Once this has been achieved and the most relevant feature groups for the production system have been identified and each of these feature groups may be assigned a unique process within the CAx chain, the production system may then be optimised with little effort.

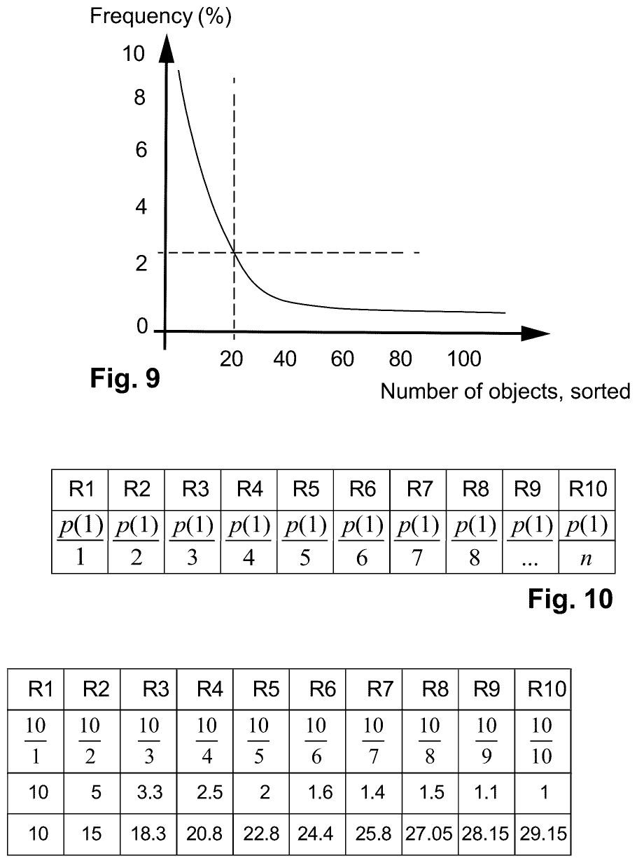

FIG. 9 shows a schematic representation of the curve of a Zipf's distribution, i.e. a frequency distribution that follows Zipf's law.

FIG. 10 shows a table with the functional variables on which a Zipf frequency distribution is based and their relationship, in particular the occurrence of the probabilities of the first 10 ranks when the frequency at rank 1 is 10%.

FIG. 11 shows sample data of a Zipf distribution, wherein the last row represents the cumulative probability of occurrence of the shape elements. In such a frequency distribution, the first 10 ranks of feature groups represent approx. 30% of all feature groups, which thus represents a suitable “resolution” of a frequency distribution. Once the most relevant feature groups for the production system have been identified with a suitable “resolution” and each of these feature groups may be assigned a unique process within the CAx chain, the production system may then be optimised with little effort.

In other words, the frequency distribution from FIG. 7 determined in a first step is adapted in an embodiment of a method according to the present invention by repeating the method steps, for example by adding and/or changing feature group data, which in particular enable a subdivision into further sub-feature groups, until a frequency distribution according to Zipf's law is obtained. The frequency distribution according to Zipf's law seems to apply to most production systems.

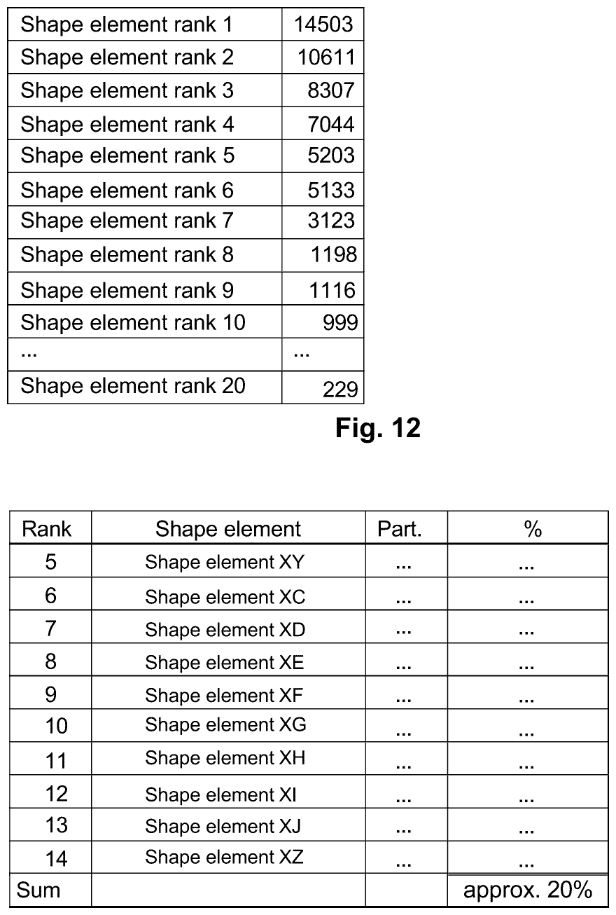

It has been shown that with a basic quantity of approx. 60,000 shape elements in a company, the most common 1600 shape elements are decisive for efficient control of the production system, in particular for efficient standardisation and optimisation of the production system, especially for an improvement of 80% of the machining processes in production planning.
FIG. 12 shows a table with sample data on the frequency distribution of various feature groups, in this case of various geometric shape elements 1 to 20, which are processed in a computer-aided production system 100, wherein the shape elements are sorted by rank depending on their frequency. shape element 1 (“hole”) has a frequency of more than 22%. However, this is not yet meaningful because no clear production process is assigned to the shape element.

By adding the nominal diameter and subdividing into sub-feature groups Shape element XY to XZ and determining the frequency distribution with the “new” feature groups, the resolution is significantly improved and the shape element of the type “Bore” with a respective nominal diameter may be identified, which occurs most frequently among the shape elements of the type “Bore”. A unique production process may now also be assigned to this. This is therefore the most relevant and has the greatest potential for improvement with regard to the control and operation of the production system (here: shape element XY). This is illustrated by FIG. 13, which shows a table for the frequency distribution of sub-shape elements X . . . of the shape element 1, which may be processed in the computer-aided production system 100, wherein the sub-shape elements are sorted by rank depending on their frequency. This example shows that in the underlying production system to which the data belong, even when broken down into sub-shape elements with just ten data records or feature groups and feature group data, 20% of all processes in the CIM architecture of the production system are already covered. Since the sub-shape elements have the same effect as the superordinate shape elements (a frequency distribution according to a non-linear, strictly monotonically decreasing function of the shape x^{-e} with e=1 according to Zipf's law or the Pareto principle, wherein x describes the rank of the frequency list or ranking list). In its original form, Zipf's law is free of parameters and e=1. This means that with just a few sub-shape elements, in this case only 10, approx. 20% of the total expenditure in the CIM architecture may be covered.

In particular, an evaluation depending on the
the frequency of all shape elements per work step/routing/component/assembly/product/year,
the production time of each individual shape element and the cumulative production time of a shape element/component/assembly/product/year,
the manufacturing costs of each individual shape element and the cumulative costs per shape element/component/assembly/product/year,
a shape element-related reject rate, which is a measure of process robustness, and the cumulative reject rate per shape element/component/assembly/product/year, and/or
a revision status.

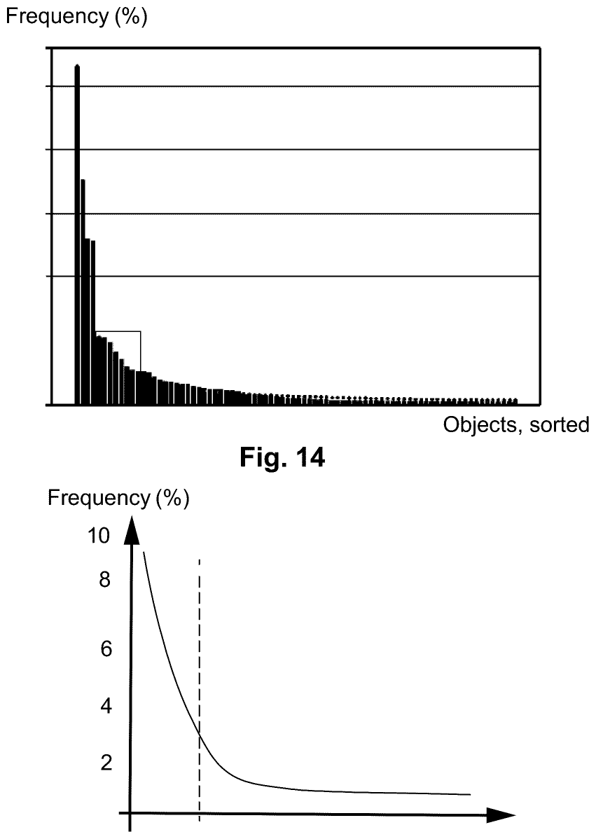

The set of shape elements assigned to a component may define the component in particular. The quantity of components assigned to an assembly may define the assembly in particular. The quantity of assemblies assigned to a product may define the product in particular. The costs and/or capacities of a product may be defined in particular by associated shape elements or associated feature groups and the associated feature group data. The cumulative quantity of the costs of each individual shape element may define the costs of work step/routing/part/assembly/product/year via the feature groups. This means that 80% of all process-related expenses in the CIM architecture of the associated production system may be identified with 20% of the shape elements sorted by frequency. FIG. 14 shows the frequency distribution of the shape elements from FIGS. 7 and 8 with shape elements or feature groups divided into sub-shape elements. FIG. 15 shows a schematic curve of the frequency distribution from FIG. 14 for the frequency distribution of the feature group “geometric shape element” over the associated geometric shape elements sorted by rank, wherein the approximation to Zipf's distribution function is recognisable here. With 20% of the feature groups, an area of about 80% under the curve may be covered.

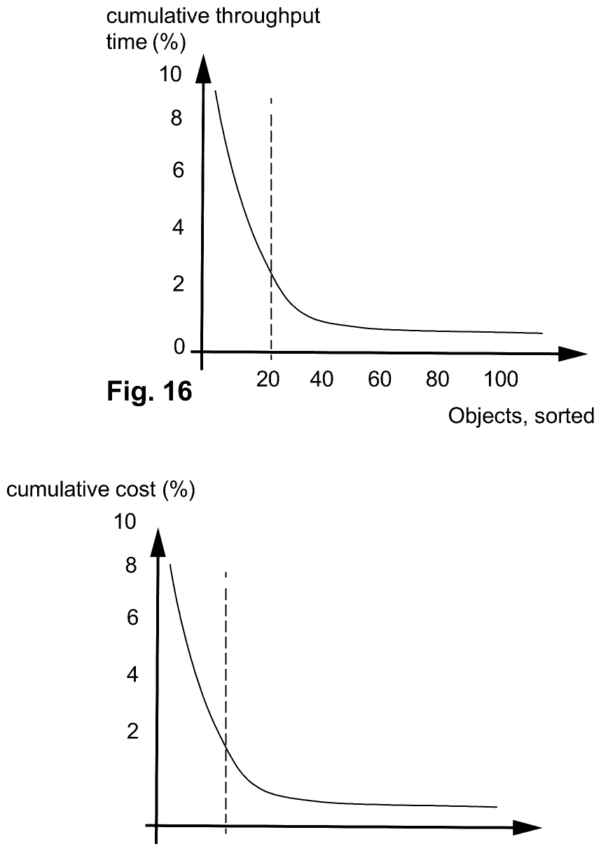

FIG. 16 shows a schematic curve of a frequency distribution for the frequency distribution of the feature group “geometric shape element x throughput time”, sorted by rank over the associated geometric shape elements, which corresponds to the representation of the cumulative throughput time. 20% of the feature groups (of the associated shape elements) are responsible for around 80% of the throughput time (area under the curve up to the 20% limit). FIG. 17 shows a schematic curve of the frequency distribution from FIG. 14 for the frequency distribution of the feature group “geometric shape element x costs” over the associated geometric shape elements sorted by rank, which corresponds to the representation of the cumulative costs. 20% of the feature groups (of the associated shape elements) are responsible for around 80% of the costs (area under the curve up to the 20% limit).

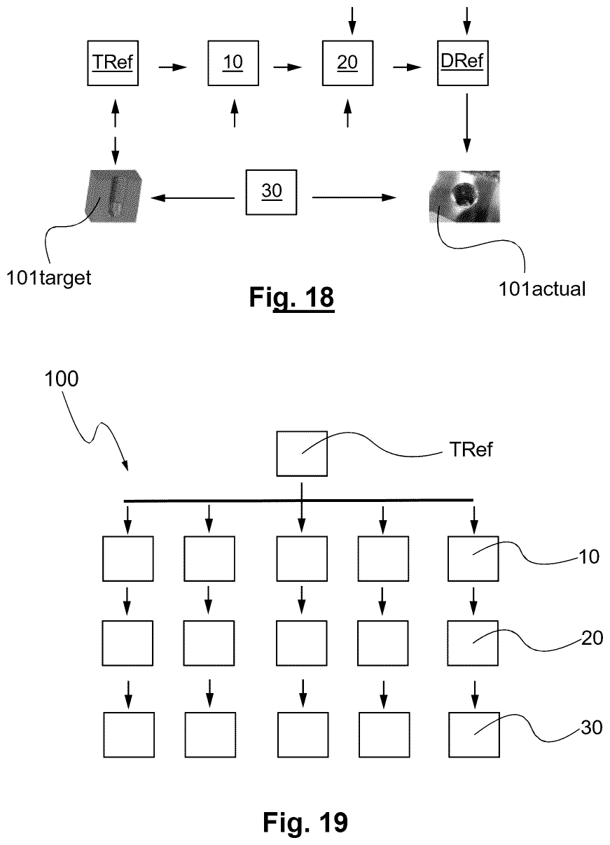

FIG. 18 shows a schematic diagram for an exemplary embodiment for the interface organisation and for possible data and information flows between the various workstations 10, 20 and 30 of a production system 100 according to the invention, wherein a feature group reference template TRef (feature group reference data set, cf. FIG. 5) is associated in particular with a CAD workstation 10 and the associated data are initially forwarded to it after a change. From there, the data, in particular the modified data, may be forwarded to a CAM station 20 and assigned by it, for example as component reference data DRef, to all components to which the respective feature group is assigned. At a test station 30, the component target data 101 target and the component actual data 101 actual meet and measures derived from these may be fed back into the feature group reference data TRef in the form of data changes to the feature group data and, for example, into the process data or the machining data of the individual workstations 10, 20 and 30.

FIG. 19 shows a further principle representation for an exemplary embodiment for possible data and information flows starting from a feature group reference template (feature group reference data set) to various CAx workstations of a production system according to the invention, wherein this principle representation shows in particular an updating process, in particular the feature group-related data updating, which may also be referred to as feature group-related process revision. The vertical chain represents the processes of the CAx chain CAD-CAM-CAQ.

An advantageous production system may also be configured to carry out a duplication step so that at least one (reference) feature group and its associated feature group data may be at least partially duplicated or copied. Optionally, the production system may also be configured to perform an adaptation step to adapt the copied feature group(s) and/or its feature group data in order to generate a new feature group. The “copying” of the position and orientation of an object, in particular a shape element, geometric bodies, associated features, associated machine (processing) features and/or parameters, appears to be particularly advantageous.

It may be particularly advantageous if a bidirectional link (relation) is maintained between the original feature group (template) and the new feature group created based on the feature group template. This enables a particularly efficient revision, for example, starting from the reference feature group for all “dependent” feature groups created based on the reference feature group and vice versa. This means that if a change is required to the new feature group, it may be integrated into the feature group template and, if necessary, into all dependent feature groups via this template.

### Further Exemplary Embodiments

Further exemplary embodiments and/or features may be:
No. 1: A computer-implemented method, preferably for use in a computer-aided production system, in particular for operating a computer-aided production system for component processing and/or manufacture and/or for controlling a computer-aided production system for component processing and/or manufacture, wherein in particular at least one method step is carried out with the aid of a data processing device and/or with the aid of a computer system, and wherein the method comprises the following steps:
a) providing data, in particular component data, which are assigned to one or more components, wherein the data contain information on two or more feature groups which are assigned to one or more components, wherein at least one feature group is assigned to each component for which data are provided, wherein a feature group in each case comprises a group of features which at least partially define the component to which the feature group is assigned, and wherein feature group data are assigned to each feature group,
b) selecting at least one feature group,
c) providing at least some of the feature group data assigned to the at least one selected feature group,
d) analysing the feature group data provided and determining a value of at least one variable characteristic of the selected feature group.
e) storing, outputting and/or further processing the at least one value determined in step d).
No. 2: A computer-implemented method according to No. 1, wherein before and/or after the provision of data in step a), in particular data are detected, in particular operating data of the production system, preferably in a separate step, in particular for detecting the data to be provided later, preferably using one or more sensor devices, in particular within the production system.
No. 3: A computer-implemented method according to No. 1 or 2, wherein before data are provided in step a), available data (stored/saved or detected data) are assigned to one or more components, wherein the data in particular contain information on one or more feature groups.
No. 4: A computer-implemented method according to No. 3, wherein at least one feature group is assigned to each component, preferably at least semi-automatically, in particular with the aid of corresponding predefined reference feature groups, which are compared with the component, wherein the sufficiently matching feature group is assigned to the component if there is a sufficient match.
No. 5: A computer-implemented method according to Nos. 1 to 4, wherein the feature group data are linked to the associated feature group or to the associated feature group and the component to which the associated feature group is assigned.
No. 6: A computer-implemented method according to No. 1 to 5, wherein a feature group comprises in particular a group of features relating to a geometric shape element, in particular a geometric base body, and the associated feature group data characterise and/or define at least the shape element.
No. 7: A computer-implemented method according to No. 6, wherein a geometric shape element comprises or is in particular a bore, an elongated hole, a thread, a stud, a cylinder, a flat surface, a parallelepiped, a chamfer, a cone, a truncated cone, a groove, a sphere, a spherical portion, a circle, a circular portion or the like, or is at least partially formed or defined from a combination thereof.
No. 8: A computer-implemented method according to no. 1 to 7, wherein the feature group data may be construction data (geometric data, dimensions, tolerances, weight, material, . . . ), administrative data (order number, part number, identification number, other recognition attribute, . . . ), manufacturing data (feed rate, cutting speed, tool data, NC program, . . . ), production data (actual manufacturing data, throughput times, . . . ), test data, cost information, planning data or other data, in particular physical or economic data.
No. 9: A computer-implemented method according to Nos. 1 to 8, wherein a feature group comprises or is a combination of feature (sub)groups, for example a combination of the feature groups “geometric shape element” and “costs” or “geometric shape element” and “throughput time” or “geometric shape element” and “reject rate”, wherein at least one feature group and/or feature (sub)group is in particular always a “geometric shape element”, and wherein each feature subgroup is or may be in particular also a feature group and may in particular be selected in step b).
No. 10: A computer-implemented method according to Nos. 1 to 9, wherein a component is assigned a plurality of feature groups and/or feature subgroups, wherein the feature groups and/or feature subgroups are in particular different and/or belong to one and the same main feature group.
No. 11: A computer-implemented method according to No. 10, wherein a main feature group is formed by the geometric shape element “bore” and a sub-feature group is in particular a feature group “bore with a defined nominal diameter”.
No. 12: A computer-implemented method according to No. 1 to 11, wherein steps c), d), e) are carried out in the following order: c), d) and e).
No. 13: A computer-implemented method according to No. 1 to 12, wherein at least steps b) and c) and/or b) to e) are repeated at least once, wherein the selection of the feature group in step b) of the second cycle is based in particular on the result of the evaluation from step e) of the first cycle.
No. 14: A computer-implemented method according to items 1 to 13, wherein in a further step c1) at least one parameter value of the provided feature group data is changed and preferably, in particular also in a further step d1), the feature group data of at least some components, preferably of all components to which the feature group with the feature group data is assigned, of which at least one parameter value has been changed, are updated.
No. 15: A computer-implemented method according to No. 1 to 14, in particular according to No. 14, wherein the feature group data of a feature group are updated at regular intervals, wherein in particular after each change to the feature group data made by a processor at a processing station, a production system-wide change is proposed, which becomes binding throughout the production system after successful release.
No. 16: A computer-implemented method, preferably for use in a computer-aided production system, in particular for operating a computer-aided production system and/or for controlling a computer-aided production system, wherein the method comprises the following steps and in particular at least one method step is carried out with the aid of a data processing device and/or with the aid of a computer system:
a) providing data which are assigned to one or more components, wherein the data contain information on two or more feature groups which are assigned to one or more components, wherein at least one feature group is assigned to each component for which data are provided, and wherein feature group data are assigned to each feature group,
b) selecting at least one feature group,
c1) changing at least one parameter value of the provided feature group data,
d1) updating the feature group data of at least some components, preferably of all components, to which the feature group with the feature group data of which at least one parameter value has been changed is assigned.
No. 17: a computer-aided production system for carrying out a method according to Nos. 1 to 16.
No. 18: A computer-aided production system according to No. 17, wherein the production system comprises one or more workstations, wherein the workstations are in particular networked with each other for communication (wireless and/or wired).
No. 19: A computer-aided production system according to No. 17 or 18, wherein the production system comprises at least one data processing device and/or at least one computer system.
No. 20: A computer-aided production system according to items 17 to 19, wherein the production system is configured to collect and store production system data during operation.
No. 21: A computer-aided production system according to items 17 to 20, wherein the production system is configured to allocate production system data, in particular production system data detected during operation, at least partially in a feature group-specific or feature group-related manner, in particular in a shape element-related manner, and preferably at least partially automated, preferably fully automated.
No. 22: A computer-aided production system according to No. 21, wherein the production system is configured to assign production system data detected in connection with the machining of a component, in particular during the machining of a component, to the feature group or feature groups which are assigned to the component, in particular to shape elements, i.e. to the shape elements which are assigned to the component, in a feature group-specific and/or feature group-related manner.
No. 23: A computer-aided production system according to items 17 to 22, wherein the production system is configured to display information about the last change and/or change history of at least some of the feature group data.
No. 24: A computer-aided production system according to No. 17 to 23, wherein the production system comprises at least one display device for displaying feature group data and/or change information on the feature group data, preferably at each workstation.
No. 25: A computer-aided production system according to items 17 to 24, wherein the production system comprises a production data management system, in particular for managing the component data, the components which may be processed within the production system and/or for managing the feature group data, wherein the production system is set up in particular to store the data centrally, preferably on at least one server, in particular on at least one server which is part of the production system and is located in particular with at least one workstation in the same network, and/or on an external server in a cloud.
No. 26: A computer-aided production system according to items 17 to 25, wherein the production system is configured to at least partially compare the data provided locally at or in the workstation for processing the component with the data stored centrally in the production data management system before starting a work process at a workstation of the production system for processing a component, wherein the production system is further configured in particular to at least temporarily block and/or stop and/or terminate the work process for processing the component in the event of a data inconsistency.
No. 27: A computer-aided production system according to items 17 to 26, wherein the production system has an evaluation device, in particular an evaluation and display device, which is set up for a feature group-related evaluation of component and/or production system data, in particular for a shape element-related evaluation of component and/or production system data.
No. 28: A computer-aided production system according to No. 27, wherein the evaluation device is configured to evaluate production system data in relation to feature groups, in particular in relation to shape elements, according to frequency, costs, resources or capacity requirements and process reliability or robustness and/or reject rate, in particular per feature group, preferably per shape element.
No. 29: A computer-aided production system according to No. 28, wherein the evaluation device is set up to distinguish feature groups, in particular shape elements, according to whether or not they require processing, in particular a physical processing step.
No. 30: A computer-aided production system according to items 17 to 29, wherein the production system has an evaluation device, in particular an evaluation and display device, which is configured to generate a component-specific feature group parts list, in particular a component-specific shape element parts list, and in particular to output and/or store it, preferably including associated modification information.
No. 31: A computer-aided production system according to items 17 to 30, wherein the production system has an evaluation device, in particular an evaluation and display device, which is set up for a feature group-related capacity requirement and/or cost calculation, in particular for a shape element-related capacity requirement and/or cost calculation.
No. 32: A computer program, wherein the computer program comprises instructions which, when the program is executed by a computer, cause the computer to perform a method according to any one of Nos. 1 to 16.
No. 33: A computer-readable storage medium, wherein the computer-readable storage medium has stored thereon a computer program according to No. 33 comprising instructions which, when the program is executed by a computer, cause the computer to perform a method according to any one of Nos. 1 to 16.
No. 34: A data processing device, in particular a computer or a control device for a production system according to one of Nos. 17 to 31, comprising means for carrying out the method according to one of Nos. 1 to 16.

Although some aspects have been described in the context of an apparatus, in particular in connection with a production system and/or a data processing apparatus, it is clear that these aspects also constitute a description of the corresponding method, where this is technically possible, wherein in particular a block or an apparatus corresponds or may correspond in particular to a method step or a function of a method step. Similarly, aspects that are described in the context of a method step also represent, where technically possible, a description of a corresponding block or element or a property of a corresponding device.

This means, in particular, that the preferred embodiments presented with reference to the method described above and their advantages also apply accordingly to a production system according to the present invention and to a computer program, a computer-readable storage medium and a data processing device according to the present invention and vice versa, even if this is not explicitly described again in each case in the corresponding places in this application, in particular in order to avoid repetitions.

The exemplary embodiments of the present invention may be realised in a computer system and/or with the aid of a computer system, in particular with a computer system for a production system or with a computer system within a production system. In particular, the computer system may comprise a data processing device according to the present invention or alternatively be a part thereof.

The computing system may be a local computing device (e.g. personal computer, laptop, tablet computer or mobile phone) with one or more processors and one or more storage devices, or a distributed computing system (e.g. a cloud computing system with one or more processors or one or more storage devices distributed at different locations, for example at a local client and/or one or more remote server farms and/or data centres). The computer system may comprise any one or more such circuits or one or more combinations of circuits. In one exemplary embodiment, the computer system may comprise one or more processors, which may be of any type. As used herein, processor may mean any type of computing circuit, such as, but not limited to, a microprocessor, a microcontroller, a complex instruction set microprocessor (CISC), a reduced instruction set microprocessor (RISC), a very long instruction word (VLIW) microprocessor, a graphics processor, a digital signal processor (DSP), a multi-core processor, a field programmable gate array (FPGA), or any other type of microprocessor; VLIW) microprocessor, a graphics processor, a digital signal processor (DSP), a multi-core processor, a field-programmable gate array (FPGA) or any other type of processor or processing circuit. Other types of circuitry that may be included in the computer system may be a custom-built circuit, an application specific integrated circuit (ASIC), or the like, such as one or more circuits (e.g., a communication circuit) for use in wireless devices such as mobile phones, tablet computers, laptop computers, two-way radios, and similar electronic systems.

The computer system may comprise one or more storage devices, which may comprise one or more storage elements suitable for the particular application, such as a main memory in the form of random access memory (RAM), one or more hard discs and/or one or more drives that handle removable media, such as CDs, flash memory cards, DVDs and the like. The computer system may also include a display device, one or more speakers, and a keyboard and/or controller, which may include a mouse, trackball, touch screen, voice recognition device, or any other device that allows a system user to input information to and receive information from the computer system.

Some or all of the method steps may be performed by (or using) a hardware device, such as a processor, a microprocessor, a programmable computer or an electronic circuit. In some exemplary embodiments, one or more of the main method steps may be performed by such a device.

Depending on specific implementation requirements, exemplary embodiments of the invention may be or may be implemented in hardware or software. The implementation may be carried out using a non-volatile storage medium such as a digital storage medium, such as a floppy disc, a DVD, a Blu-Ray, a CD, a ROM, a PROM and EPROM, an EEPROM or a FLASH memory, on which electronically readable control signals are stored, which co-operate (or may co-operate) with a programmable computer system, in particular a computer system according to the invention, and/or a data processing device, in particular a data processing device according to the invention, in such a way that the respective method is carried out. The digital storage medium may therefore be computer-readable.

Some possible embodiments according to the invention comprise a computer-readable storage medium, in particular a data carrier, with electronically readable control signals which may interact with a programmable computer system, in particular a computer system according to the invention, and/or a data processing device, in particular a data processing device according to the invention, so that one of the methods described herein is carried out.

In general, embodiments of the present inventions, in particular embodiments of the method inventions, may be implemented as a computer program product comprising a program code, wherein the program code is effective for executing one of the methods when the computer program product is running on a computer. The program code may be stored on a machine-readable medium, for example.

Further exemplary embodiments comprise a computer program for performing one of the methods described herein, which is stored on a machine-readable medium.

In other words, an exemplary embodiment of the present invention may therefore be a computer program comprising a program code for performing any of the methods described herein, wherein the computer program runs on a computer.

Thus, another possible embodiment of the present invention is, for example, a storage medium (or a data carrier or a computer readable medium) comprising a computer program stored thereon for executing one of the methods described herein when executed by a processor. The data carrier, the digital storage medium or the detected medium are usually tangible and/or non-transitory. Another exemplary embodiment of the present invention may be, for example, a device as described herein comprising a processor and the storage medium.

Another exemplary embodiment of the invention may be a data stream or signal sequence representing the computer program for performing one of the methods described herein. The data stream or the signal sequence may, for example, be configured so that the transmission may or does take place via a data communication link, for example via the Internet.

However, a data stream or a signal sequence that is transmitted via a data communication link may also only comprise individual data or data packets of individual method steps and does not necessarily have to represent the computer program. For example, a data stream or a signal sequence may contain component and/or feature group data that is transmitted to a data processing device via a data communication connection, for example via WLAN or LAN, in particular from one or more workstations and/or from one or more readable data storage devices of the production data management system to the data processing device in order to provide data in step a).

Likewise, a data stream or a signal sequence may contain component and/or feature group data and/or one or more evaluation results and values determined during the evaluation in step d), which are transmitted via a data communication connection from a data processing device, for example via WLAN or LAN, in particular to one or more workstations and/or to one of the several data memories of the production data management system.

Another exemplary embodiment comprises a processing means, for example a computer or programmable logic device, configured or adapted to perform any of the methods described herein.

Another exemplary embodiment comprises a computer on which the computer program for executing one of the methods described herein is installed.

Another exemplary embodiment according to the invention comprises a device or system configured to transmit (for example, electronically or optically) a computer program to a receiver for performing any of the methods described herein. The receiver may be, for example, a computer, a mobile device, a storage device or the like. For example, the device or system may include a file server for transferring the computer program to the recipient.

In some exemplary embodiments, a programmable logic device (e.g., a field programmable gate array, FPGA) may be used to perform some or all of the functionalities of the methods described herein. In some exemplary embodiments, a field programmable gate array may co-operate with a microprocessor to perform any of the methods described herein. In general, the procedures are preferably carried out by each hardware device.

In addition to the embodiments and exemplary embodiments described, further embodiments are possible, in particular of a constructive nature, without leaving the scope of protection defined by the patent claims.

### LIST OF REFERENCE SIGNS

100 Production system according to the invention
130 Data processing apparatus according to the invention
140 Data memory (computer-readable storage medium according to the invention)
10 CAD workstation
20 CAM workstation
30 CAQ workstation
35 Production planning, especially product-specific
40 Production planning and control, especially order-related
50 Product program planning workstation
60 Quantity planning workstation
70 Scheduling and capacity planning workstation
80 Order monitoring workstation
90 Order initiation workstation
101 Component
101actual Actual component
101target Target component
102 Data communication connection for data transmission
103 Data communication connection for data transmission
104 Data communication connection for data transmission
105 Data communication connection for data transmission
106 First feature group “geometric shape element hole”
107 Feature group data category “Components/year”
108 Feature group data category “Number/type of feature groups”
109 Second feature group “geometric shape element cuboid”
110 Cloud
111 Feature group data category “Material”
112 Feature group data category “Key figures (KPIs)”
113 Feature group data main category “Testing and production process”
114 Feature group data subcategory “Production equipment and production aids”
115 Feature group data subcategory “Strategy/production organisation”
116 Feature group data subcategory “Test and production parameters”
120 Production Data Management System (PDMS)
DREF Component reference data
S1 . . . S8 Method steps of a first exemplary embodiment of a method according to the invention
S1A . . . S4A Method steps of a further advantageous process
TRef Feature group reference template (feature group reference data set)

1. A computer-implemented method for use in a computer-aided production system (100) for component processing, in particular for controlling an operation of a computer-aided production system (100) for component processing, wherein the method comprises at least the following steps:
a1) providing (S1) component data assigned to one or more components (101) that may be manufactured and/or processed by the computer-aided production system (100),
wherein the component data contain information on two or more feature groups (106, 109) which are assigned to one or more components (101), wherein at least one feature group (106, 109) is assigned to each component (101) for which data are provided,
wherein a feature group (106, 109) in each case comprises a group of features which at least partially define the component (101) to which the feature group (106, 109) is assigned, and
wherein feature group data (107, 108, 111, . . . , 116) are assigned to each feature group (106, 109),
a2) detecting operating data of the production system (100) and assigning the detected operating data of the production system (100) to at least one feature group (106, 109), whereby the detected operating data of the production system (100) become feature group data (107, 108, 111, . . . , 116),
b) selecting (S2) at least one feature group (106),
c) providing (S3) at least some of the feature group data (107, 108, 111, . . . , 116) which are assigned to the at least one selected feature group (106), wherein the provided feature group data (107, 108, 111, . . . , 116) contain at least some of the operating data of the production system (100) detected in step a2) and assigned to the feature group (106),
d) analysing (S4) the feature group data (107, 108, 111, . . . , 116) provided and determining a value of at least one variable characteristic of the selected feature group (106), and
e) storing, outputting and/or further processing (S5) of the at least one value determined in step d).

2. The method according to claim 1, wherein in step e) at least one determined value is output, and wherein the at least one determined and output value is used in a further step of the method, in particular for controlling the production system (100).

3. The method according to claim 1 or 2, wherein at least one feature group, in particular each feature group, has at least one geometric shape element and/or at least one feature dependent on a geometric shape element, wherein the associated feature group data contain in particular operating data, preferably geometry and/or production data, relating to the at least one geometric shape element.

4. The method according to any one of claims 1 to 3, wherein the selection of the at least one feature group is performed in dependence on a frequency distribution of at least one of the part of the feature groups.

5. The method according to any one of claims 1 to 4, wherein the selection of the feature group is performed with the aid of Zipf's law based on the determined frequency distribution, wherein a rank is assigned to the feature groups as a function of their frequency according to Zipf's law and the feature group is selected as a function of its rank.

6. The method according to any one of claims 1 to 5, wherein in a further step it is checked whether the value determined in step d) lies within a predefined, permissible value range.

7. The method according to any one of claims 1 to 6, wherein in a further step, in particular in a step f), preferably as a function of the value of the at least one characteristic variable determined in step d), at least one measure is initiated, wherein preferably at least one parameter value, in particular of at least one parameter of the feature group data of the at least one selected feature group is changed and/or one or more parameters and their associated values are added to the data, in particular to the feature group data of the at least one selected feature group, wherein in particular a value of at least one control parameter for controlling the production system and/or at least one value of another parameter of the production system, in particular a component parameter, is changed or added or removed.

8. The method according to any one of claims 1 to 7, wherein the changed parameter value and/or one or more parameters to be added or removed and their parameter values as well as information about the associated change(s) are stored centrally in a production data management system (120) or directly in a production planning and control system (40) of the production system (100).

9. The method according to any one of claims 1 to 8, wherein the parameter value and/or one or more parameters to be added and their parameter values as well as information about the associated change(s) is/are changed across all components to which the at least one selected feature group is assigned.

10. The method according to any one of claims 1 to 9, wherein, in particular during an operation of the production system, before a work process is started at a workstation (10, 20, 30, 50, . . . 90) of the production system for machining a component, the data provided locally at or in the workstation for machining the component are at least partially compared with data stored centrally in the production data management system (120) or with data stored in the production planning and control system (40), wherein, in the event of a data inconsistency, in particular the work process for machining the component is at least temporarily blocked and/or stopped and/or terminated.

11. A computer-aided production system (100), characterised in that the production system (100) is configured to carry out a method according to one of claims 1 to 10.

12. The production system (100) according to claim 11, wherein the production system is further configured to at least partially compare the data provided locally at or in the workstation for processing the component with data stored centrally in the production data management system (120) or with data stored in the production planning and control system (40) before starting a work process at a workstation of the production system for processing a component, wherein the production system is further configured in particular to at least temporarily block and/or stop and/or terminate the work process for processing the component in the event of a data inconsistency.

13. A computer program, wherein the computer program comprises instructions which, when the program is executed by a computer, cause the computer to perform a method according to any one of claims 1 to 10.

14. A computer-readable storage medium, wherein stored on the computer-readable storage medium is a computer program according to claim 13, comprising instructions which, when the program is executed by a computer, cause the computer to perform a method according to any one of claims 1 to 10.

15. A data processing device, in particular a computer or a control device for a production system according to claim 11, comprising means for carrying out the method according to any one of claims 1 to 10.
